(19) United States
(12) Patent Application Publication
(10) Pub. No.: US 2026/0087043 A1
(43) Pub. Date: Mar. 26, 2026

(54) MODEL-BASED PERSONAL ADVISOR SYSTEM

(71) Applicant: Wells Fargo Bank, N.A., San Francisco, CA (US)

(72) Inventors: Michael Liersch, New York, NY (US); Evelyn Varner, Boston, MA (US); David J. Furst, Saint Louis, MO (US)

(21) Appl. No.: 19/337,525

(22) Filed: Sep. 23, 2025

Related U.S. Application Data
(60) Provisional application No. 63/698,344, filed on Sep. 24, 2024.

(51) Int. Cl. G06F 16/3329; G06F 16/335; G06Q 10/0637

(52) U.S. Cl. CPC G06F 16/33295; G06F 16/337; G06Q 10/0637

(57) ABSTRACT

Systems, apparatuses, methods, and computer program products are disclosed for providing a multimodal interactive personal advisor (MIPA). An example method includes retrieving first user data associated with a user. The example method also includes facilitating an first interaction between the user and an MIPA model via a first user device. The example method also includes extracting, based on the first interaction, a set of data features associated with the user and determining, based on the set of data features, second user data. The example method also includes generating, based on the first user data and the second user data, a first model response and providing the first model response to the user via a second user device associated with the user.

### CROSS REFERENCE TO RELATED APPLICATIONS

This patent application claims the benefit of U.S. Provisional Patent Application No. 63/698,344 filed Sep. 24, 2024, which is hereby incorporated by reference in its entirety.

### BACKGROUND

Managing life events, finances, logistics, and/or family needs may be, at times, an overwhelming endeavour. Furthermore, conventional software-based systems and techniques for managing such life events, finances, logistics, and/or family needs exhibit numerous drawbacks, inefficiencies, and limitations.

### BRIEF SUMMARY

Conventional systems and techniques for planning goals (e.g., financial goals) may be configured to provide high-level outlooks and/or suggestions for users based on institutional best practices. For example, wealth management firms often use software-based investment calculators to estimate the future value of user's investment portfolio once the user reaches retirement age. As another example, conventional systems and techniques for planning goals may assist in visualizing a user's progress towards a financial budgeting or savings goal.

However, historically, enterprises (e.g., financial institutions, banks, corporations, and/or the like) have not had an efficient, effective way to identify and present potential user-specific goals or opportunities, and/or generate plans-of-action for achieving such user-specific goals or opportunities. For example, while conventional systems (e.g., retirement calculators, budgeting software) may indicate to a user an amount of funds that may be required to achieve a specific goal (e.g., comfortably retire, take an international vacation), conventional systems may not indicate the various methods or actionable steps necessary to achieve the specific goal in an efficient, optimized manner.

In contrast to conventional techniques for planning goals (e.g., financial goals, retirement goals), various examples described herein comprise an artificial intelligence (AI)-based multimodal interactive personal advisor (MIPA) system configured to generate various pathways (e.g., actionable plans) for a user without relying on manual data input from the user (e.g., manual financial data input). The MIPA system employs an AI-based MIPA model configured to interact with a user via a number of modalities to create a seamless user experience and may determine (e.g., infer, predict) a user's financial outlook, goals, objectives, and/or potential opportunities for the user based on a variety of interactions with the user. As the MIPA model is intended to serve as an “always-on”, omnipresent entity to assist users, the MIPA model may be configured to just “be there” from the start; in other words, requiring a user to configure or otherwise set up the MIPA model (e.g., manually submit financial information, account information, career information) may detract from the user experience.

In this regard, the MIPA system provides a benefit in that the MIPA model may require no explicit input from a respective user during initial configuration for the respective user. Instead, the MIPA model may be configured to generate a user profile or account in the backend of the MIPA system by aggregating enterprise data and/or user data from multiple enterprises (e.g., financial institutions, governmental institutions, organizations, companies, and/or the like with which the user is affiliated). Additionally, the MIPA model may be configured to extract various data features from various user interactions (e.g., text-, speech-, and/or video-based interactions, documentation uploads, user input, and/or the like) in order to determine and/or process various user data which may be used in the generation and continuous updating of a user profile and/or various hyper-personalized pathways, opportunities, recommendations, and/or the like associated with a respective user.

For example, user data associated with a respective user (e.g., user data, enterprise data) may include financial data (e.g., financial transaction history data, financial account balance data, credit history data, debt data, loan data), personally identifiable information (PII), demographic information, personal relationship data (e.g., data associated with a user's spouse, partner, family, friends, pets), life event data (e.g., data related to major events impacting a user's life such as divorce), behavioral data (e.g., online activity, data associated with enterprise branch visits, data associated with user interactions with customer service individuals and/or enterprise-managed chatbots), cost-of-living data, user device data, social media data, and/or the like associated with the user. Such user data may be processed by the MIPA model and transformed into meaningful features related to a user's financial status, financial patterns (e.g., savings trends, patterns of income and spending, debt repayment patterns, credit utilization), living situation, life events, inferred goals, potential meaningful opportunities, and/or the like.

In various embodiments, a user may be enabled to interact with the MIPA model via a number of technological platforms and in various ways. For example, the user may interact with the MIPA model via a smart home device, a software application instance running on a user device (e.g., a smartphone, laptop), a web browser extension (e.g., a plugin, auxiliary software application embedded in the web browser), an embedded computing device (e.g., a central computing device in an automobile), and/or the like. As such, the user may be enabled to interact with the MIPA model in a number of ways including conversational speech, text-based communication (e.g., direct chat, email, SMS), and/or via various body gestures.

In this regard, the MIPA model may be configured to retrieve, receive, aggregate, compile, and/or otherwise process user data associated with a respective user by way of a series of interactions with the user, as well as by leveraging any enterprise data (e.g., financial data, user account data, user profile data) associated with the user in order to generate a user profile and/or determine one or more goals, interests, objectives, or life events the user may have or experience. Additionally, the MIPA model may be configured to retrieve, receive, aggregate, compile, and/or otherwise process various external data (e.g., legislative data, tax data, real estate data, financial data, market data, cost-of-living data, news data, current event data, product and/or product offer data) that may be relevant to a user's goals, interests, objectives, and/or life events. As such, the MIPA model may be configured to leverage such user data and/or external data to generate and/or manage a user's profile as well as determine and provide various pathways, opportunities, and/or recommendations for the user. For example, the MIPA model may determine, based on various interactions (e.g., conversations, digital communications), that a respective user has had a development in their education or career (e.g., graduated from university, obtained a new job, death of a spouse), is moving to a new location, has experienced a major life event (e.g., divorce, birth of a child), has decided to retire by a certain age, wishes to buy a house, has become a primary caretaker for a loved one, and/or the like, and may assist the user by generating and implementing a step-by-step plan for the user to follow in order to achieve various goals.

Accordingly, the present disclosure sets forth systems, methods, and apparatuses that provide MIPA for one or more respective users. There are many advantages of these, and other examples described herein. One advantage the MIPA system provides, as described herein, is an improvement to the functioning of the computing infrastructure of an enterprise, such as by reducing the burden on computing and personnel resources. For instance, the MIPA system described herein reduces the complexity of generating one or more actionable goals for a respective user by, among other things, automating processes such as determining various elements that impact a respective user's current financial status (e.g., income, savings, investments, debts, dependents), determining various scenarios and potential outcomes of executing various actions, and determining how executing a particular action impacts the progress of various ongoing goals undertaken by the respective user.

Due to the specific needs, background, resources (e.g., financial status), and context associated with a respective user, generalized recommendations and/or advice for how the respective user might achieve their goals may not be appropriate nor desirable. As such, various embodiments described herein provide the benefit of generating and executing (in whole or in part) hyper-personalized goals (e.g., primary goals, subgoals), insights, opportunities, scenarios, action item lists, and/or tradeoffs associated with one or more pathways (e.g., hyper-personalized actionable plans) which the respective user may endeavor to complete. Such specificity provides an improvement over conventional generalized planning applications (e.g., retirement calculators, investment forecasting programs) as the pathways generated by the MIPA model provide real-world, step-based action items relevant to the individual circumstances of the respective user.

As described herein, another advantage provided by various embodiments is the distributed nature of the MIPA system. The MIPA model associated with the MIPA system is always on and constantly monitoring the respective user to track, update, and adjust various pathways. In this regard, the MIPA system provides a seamless user experience. For example, if the respective user initiates a discussion with the MIPA model, begins exploring a scenario, or starts to formulate a set of goals via a first platform (e.g., a smart home device located in the user's kitchen), the user may continue said discussion, scenario exploration, and/or goal formulation via a second platform (e.g., via a software application instance associated with the MIPA system running on a user device (e.g., a smartphone) as the user leaves their home. In this regard, the MIPA system may be configured such that a user profile and/or the MIPA model associated with a respective user is continuously updated based on each interaction with the user no matter which modality the user utilizes to access the MIPA system. This provides the advantage of enabling the respective user to pick up where they left off no matter which means and/or computing devices are utilized to access the MIPA system and/or MIPA model. This result is not achievable using legacy advising platforms, because it is simply not possible to have a human advisor near the user at all times. In addition, because this “always-on” functionality is provided via the MIPA model, the advice the system offers will be consistent throughout the day (as opposed to in a human powered advising platform, in which advice is either offered on a delay when the advisor is not available, or is offered in real-time, but not necessarily from a user's preferred advisor).

The foregoing brief summary is provided merely for purposes of summarizing some examples described herein. Because the above-described examples are merely examples, they should not be construed to narrow the scope of this disclosure in any way. It will be appreciated that the scope of the present disclosure encompasses many potential examples in addition to those summarized above, some of which will be described in further detail below.

### BRIEF DESCRIPTION OF THE FIGURES

Having described certain examples in general terms above, reference will now be made to the accompanying drawings, which are not necessarily drawn to scale. Some examples may include fewer or more components than those shown in the figures.

FIG. 1 illustrates a system in which some examples may be used for incorporating an MIPA system.

FIG. 2 illustrates a schematic block diagram of example circuitry embodying a system device that may perform various operations in accordance with some examples described herein.

FIG. 3 illustrates example user interfaces of an example software application instance associated with an MIPA system configured to provide MIPA in accordance with some examples described herein.

FIG. 4 illustrates additional example user interfaces of an example software application instance associated with an MIPA system configured to provide MIPA in accordance with some examples described herein.

FIG. 5 illustrates additional example user interfaces of an example software application instance associated with an MIPA system configured to provide MIPA in accordance with some examples described herein.

FIG. 6 illustrates additional example user interfaces of an example software application instance associated with an MIPA system configured to provide MIPA in accordance with some examples described herein.

FIG. 7 illustrates additional example user interfaces of an example software application instance associated with an MIPA system configured to provide MIPA in accordance with some examples described herein.

FIG. 8 illustrates additional example user interfaces of an example software application instance associated with an MIPA system configured to provide MIPA in accordance with some examples described herein.

FIG. 9 illustrates an example dataflow diagram for generating a pathway for a respective user in accordance with some examples described herein.

FIG. 10 illustrates an example dataflow diagram for determining a living location for a user based on a financial status of the user in accordance with some examples described herein.

FIG. 11 illustrates an example flowchart diagram for continuously configuring a user profile associated with a user in accordance with some examples described herein.

FIG. 12 illustrates an example flowchart diagram for executing a user check-in interaction in accordance with some examples described herein.

FIG. 13 illustrates an example flowchart diagram for generating and providing various model responses via multiple user devices associated with a user in accordance with some examples described herein.

### DETAILED DESCRIPTION

Some examples will now be described more fully hereinafter with reference to the accompanying figures, in which some, but not necessarily all, examples are shown. Because inventions described herein may be embodied in many different forms, the invention should not be limited solely to the examples set forth herein; rather, these examples are provided so that this disclosure will satisfy applicable legal requirements.

The term “user device,” “enterprise computing device,” or “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), embedded computers, and similar electronic devices equipped with at least a processor and any other physical components necessarily to perform the various operations described herein. Devices such as smartphones, laptop computers, tablet computers, and wearable devices may be generally referred to as mobile devices.

The term “server” or “server device” refers to any computing device capable of functioning as a server, such as a master exchange server, web server, mail server, document server, or any other type of server. A server may be a dedicated computing device, or a server module hosted by a computing device that causes the computing device to operate as a server.

### System Architecture

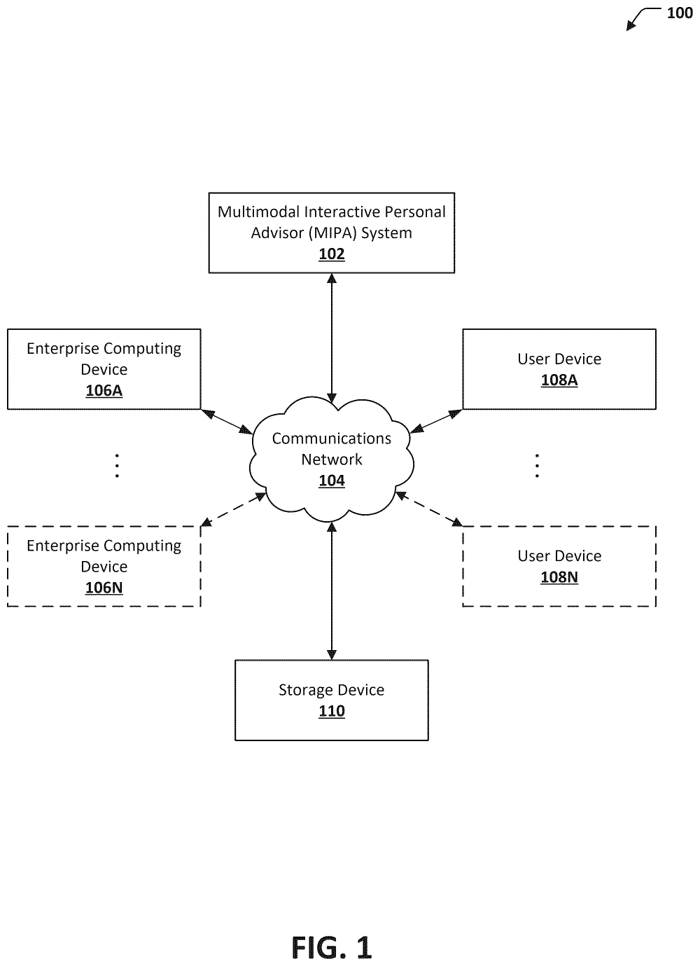

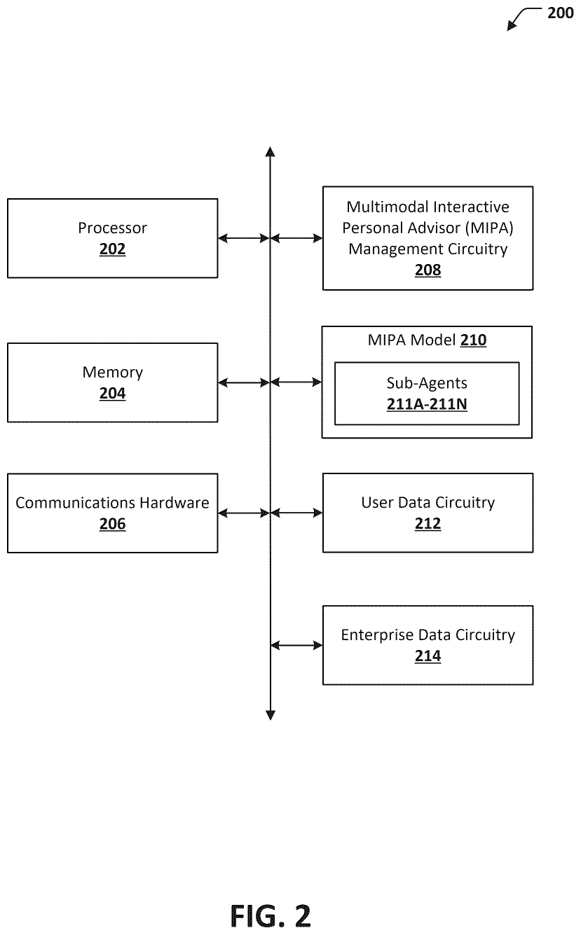

Examples described herein may be implemented using any of a variety of computing devices or servers. To this end, FIG. 1 illustrates an example environment 100 within which various examples may operate. As illustrated, an MIPA system 102 may receive and/or transmit information via communications network 104 (e.g., a telecommunications network (e.g., 5G network), wide area network (WAN), local area network (LAN), wireless Internet network, and/or the like capable of facilitating remote network communications) with any number of other devices, such as one or more of enterprise computing devices 106A-106N and/or user devices 108A-108N. The MIPA system 102 may be implemented as one or more computing devices or servers, which may be composed of a series of components. Particular components of the MIPA system 102 are described in greater detail below with reference to apparatus 200 in connection with FIG. 2.

In various examples, the MIPA system 102 may be associated with an enterprise (e.g., a financial institution, bank, and/or the like) and may be configured to manage various MIPA processes for said enterprise. For example, the MIPA system 102 may be configured to manage, execute, initiate, and/or otherwise facilitate one or more data ingestion processes, data feature extraction processes, data inference processes, pathway generation processes, opportunity determination processes, financial status determination processes, AI model setup configuration processes, user engagement processes (e.g., communications facilitation), user monitoring processes, user experience configuration processes, AI model training and refinement processes, data management processes (e.g., enterprise data management, external data management), and/or the like for a respective enterprise.

In some examples, various users associated with an enterprise may interact with the MIPA system 102 via a software application instance, where the software application instance may be configured to facilitate one or more of the various MIPA processes described herein. In various examples, the software application instance associated with the MIPA system 102 may be installed and/or downloaded to a computing device (e.g., a user device 108A) and may present one or more user interface configurations to a respective user. As such, the software application instance associated with the MIPA system 102 may be configured to guide a user through the various steps operations described herein.

For example, the software application instance associated with the MIPA system 102 may be configured to cause display of various interactive user interface elements to the user to facilitate the retrieval of a software application. Additionally, in various examples, the software application instance associated with the MIPA system 102 may be configured to enable a user to access a software application framework related to a respective enterprise by, for example, granting (e.g., transmitting, enabling, toggling, configuring) one or more access permissions for an enterprise computing device (e.g., an enterprise computing device 106A) associated with the user, where the one or more access permissions enable the user device to access the software application framework associated with the enterprise.

In some examples, the MIPA system 102 includes, embodies, and/or otherwise integrates with one or more AI models. For example, the MIPA system 102 may be configured to leverage a MIPA model. In various examples, the MIPA model may be configured to execute various AI, generative AI, machine learning (ML), machine vision (MV), body language interpretation, biometric analysis, natural language processing (NLP), speech recognition, and/or optical character recognition (OCR) techniques. For example, the MIPA model may be configured to process and/or extract features from one or more data sources (e.g., video data streams, audio data streams, text data streams, data stored in a storage device), either simultaneously or sequentially, and then execute one or more speech recognition, text data recognition, facial recognition, and/or body language recognition techniques. As such, the MIPA model may be configured to process and/or extract various data features associated with a respective user from the one or more data sources in order to determine various goals, objectives, scenarios, interests, and/or life events of the user, and/or to determine various opportunities for the user.

In this regard, the MIPA model may be configured to utilize various NLP, OCR, or similar techniques to extract various data features from documentation (e.g., electronic documentation such as email, and/or scanned copies of physical documentation) received from a respective user. In various embodiments, the various data features may include text data features (e.g., text string data, text content, words, phrases, substring data), text placement data features (e.g., paragraph styles, text placement and/or position relative to the overall document), text format data features (e.g., fonts, emphasis, styles), image data features (e.g., image placement, image content), and/or scannable imprint features (e.g., QR codes, barcodes, watermarks, document identification codes). Additionally or alternatively, in examples in which the documentation is digital correspondence (e.g., email, SMS message,), the data features extracted by the MIPA model may further comprise hyperlink data features (e.g., web address data), interactive user interface element data features (e.g., HyperText Markup Language (HTML) data, control element data), image metadata features, and/or the like.

Additionally or alternatively, based on various audio data input captured from a respective user by a user device (e.g., user device108A), the MIPA model may extract, identify, classify, and/or otherwise determine various data features related to one or more portions of acoustic feature data, valence data (e.g., whether a portion of audio data input is related to a positive or negative emotion), arousal data (e.g., how excited or apathetic a user may be), dominance data (e.g., how dominant or submissive a user may be), intensity data (e.g., volume data, gain data), intonation data, speech rate data, mel-frequency cepstral coefficient (MFCC) data, and/or the like from the audio data input. Additionally or alternatively, in some examples, the MIPA model may be configured to employ one or more NLP techniques to extract one or more utterances, words, sentences, phrases, and/or the like from the audio data input provided by a respective user in order to determine the context, meaning, emotion, and/or intention associated with various speech input provided by the user. Furthermore, the MIPA system 102 may utilize such data features to authenticate the user for various operations (e.g., voice recognition).

Additionally or alternatively, the MIPA model associated with the MIPA system 102 may be configured to extract, identify, classify, and/or otherwise determine various data features related to one or more body features (e.g., facial features, eye features, body features, gestures) from image data (e.g., video data, still image data) captured by one or more imaging devices associated with the user with which the MIPA system 102 may be integrated with (e.g., cameras associated with a user device 108A, cameras associated with a smart home device, and/or the like). For example, the MIPA model may extract, identify, classify, and/or otherwise determine one or more portions of facial feature data, facial expression data, eye feature data, eye movement data, body posture data, hand gesture data, sign language data, and/or the like from the video data. Such data features may be used by the MIPA system 102 to authenticate the user (e.g., facial recognition, eye-based recognition) for various operations and/or to determine a user's sentiment, intention, mood, and/or current emotional state.

In various examples, the MIPA model may be a supervised or unsupervised model and may be configured as an artificial neural network (ANN), recurrent neural network (RNN), convolutional neural network (CNN), long short-term memory (LSTM) network, non-linear optimization model, multi-objective optimization model, transformer model, rules-based model, or any other suitable deep learning model. In some examples, the MIPA system 102 may be configured to embody and/or integrate with one or more discrete ML models configured to perform specific tasks associated with the methods described herein. As such, an MIPA model associated with the MIPA system 102 may comprise and/or leverage multiple discrete ML models configured to perform specific tasks.

In some examples, the MIPA system 102 may train (e.g., initially, periodically, iteratively) a supervised MIPA model (e.g., using labeled training data, classification, regression) described herein to perform one or more operations described in further detail in connection with FIGS. 2-13. In other examples, the MIPA system 102 may train (e.g., initially, periodically, iteratively) an unsupervised MIPA model using unsupervised training techniques (e.g., using unlabeled training data, clustering, association) described herein to perform one or more operations described in further detail in connection with FIGS. 2-13. Furthermore, in some examples, an instance of a MIPA model may be associated with a respective user. As such, the MIPA system 102 may be configured to continuously update (e.g., retrain, refine) a respective instance of an MIPA model based on one or more interactions associated with the respective user. These and other operations executed by the MIPA model will be described in greater detail herein below with reference to FIGS. 2-13.

In some examples, the MIPA system 102 further includes a storage device 110 that comprises a distinct component from other components of the MIPA system 102. The storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally or alternatively, the storage device 110 may host the software executed to operate the MIPA system 102. Additionally or alternatively, the storage device 110 may store information relied upon during operation of the MIPA system 102, such as various user data, enterprise data, external data, AI model input data, AI model output data, AI model training data, enterprise data, and/or the like configured in various data formats to be utilized by the MIPA system 102. In addition, the storage device 110 may store control signals, device characteristics, and/or access credentials enabling interaction between the MIPA system 102 and/or one or more of the enterprise computing devices 106A-106N or user devices 108A-108N.

In various examples, the one or more enterprise computing devices 106A-106N and/or the one or more user devices 108A-108N may be embodied by any computing devices known in the art. The one or more enterprise computing devices 106A-106N and/or the one or more user devices 108A-108N need not themselves be independent devices but may be peripheral devices communicatively coupled to other computing devices.

### Example Implementing Apparatus

The MIPA system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 2-13. As illustrated in FIG. 2, the apparatus 200 may include processor 202, memory 204, communications hardware 206, MIPA management circuitry 208, user data circuitry 212, and/or external data circuitry 214, each of which will be described in greater detail below.

The processor 202 (and/or co-processor or any other processor assisting or otherwise associated with the processor) may be in communication with the memory 204 via a bus for passing information amongst components of the apparatus 200. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device 110, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various examples of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to carry out various functions in accordance with examples contemplated herein.

The communications hardware 206 may be any means such as a device or circuitry embodied in either hardware or a combination of hardware and software that is configured to receive and/or transmit data from/to a network (e.g., communications network 104) and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some examples, to receive an indication of user input. In this regard, the communications hardware 206 may comprise a user interface, such as a display, and may further comprise the components that govern use of the user interface, such as a web browser, software application instance, dedicated client device, or the like. In some examples, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

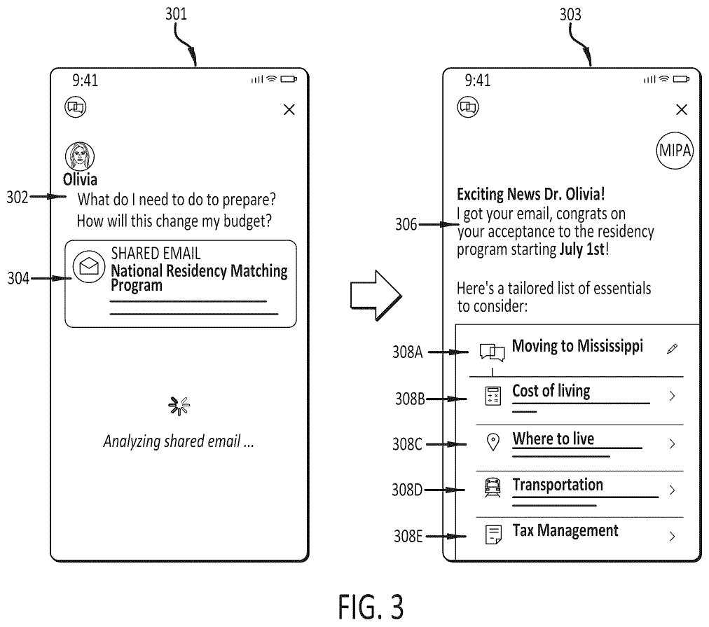

In addition, the apparatus 200 further comprises MIPA management circuitry 208. In some examples, the MIPA management circuitry 208 may be configured to facilitate the execution of one or more MIPA operations for an enterprise associated with the MIPA system 102. As such, the MIPA management circuitry 208 may utilize the communications hardware 206 to gather data from, or transmit data to, a variety of sources (e.g., the enterprise computing devices 106A-106N, the user devices 108A-108N, social media networks, consumer banking servers, third-party server systems, and/or any storage devices (e.g., storage device 110) associated with the MIPA system 102), and/or exchange data with a user. Additionally, the MIPA management circuitry 208 may utilize processor 202, memory 204, the user data circuitry 212, the external data circuitry 214, and/or any other hardware component included in the apparatus 200 (e.g., one or more cameras, global positioning service (GPS) devices, and/or the like) to perform these operations, as described in connection with FIGS. 3-13 below.

Furthermore, in various examples, the MIPA management circuitry 208 may be configured to leverage the processor 202, the memory 204, and/or the communications hardware 206 to generate, cause transmission of, and/or cause display of a plurality of interactive user interface elements on a user interface associated with a software application instance associated with the MIPA system 102 on a computing device (e.g., user device 108A). The plurality of interactive user interface elements may be configured as one or more interactive text fields, buttons, selectable images, hyperlinks, radio buttons, sliders, embedded multimedia modules, maps, charts, graphs, prompts, notifications, banners, instructions, and/or the like configured to initiate execution of one or more commands (e.g., executable software instructions) designed to facilitate the capture of one or more portions of user input. In this regard, the MIPA management circuitry 208 may be configured to leverage a plurality of interactive user interface elements in order to communicate (e.g., display) an indication of a respective goal (e.g., primary goal, subgoal), opportunity (e.g., financial opportunity), scenario, tradeoff, action item list, and/or the like.

In various examples, the MIPA management circuitry 208 may work in conjunction with (e.g., may direct, manage, embody, and/or otherwise integrate with) a MIPA model 210 in order to execute one or more of the methods described herein. As such, the MIPA management circuitry 208 may be configured to facilitate the transfer of various model input and/or model output to and/or from the MIPA model 210. Furthermore, the MIPA management circuitry 208 may be configured to facilitate the training, updating, retraining, and/or refining of the MIPA model 210. Additionally, in some examples, the MIPA management circuitry 208 may be configured to execute one or more operations associated with one or more portions of model output generated by the MIPA model 210. For example, the MIPA model 210 may generate model output associated with executing one or more actions items on behalf of the user. In such examples, the MIPA management circuitry 208 may be configured to facilitate the execution of various operations suggested, recommended, and/or delegated to the MIPA model 210 (e.g., based one or more commands and/or instructions issued to the MIPA model 210 by a respective user).

The MIPA model 210 may be configured to derive a user's outlook (e.g., financial outlook, future outlook), goals, objectives, and/or determine potential opportunities in order to generate various pathways (e.g., hyper-personalized actionable plans) for a user without relying on manual data input from the user. In some examples, the MIPA model 210 may be configured to access both internal financial accounts associated with a respective enterprise (e.g., checking, savings, and/or investment accounts associated with a financial institution) and/or external financial accounts (e.g., third party bank accounts, credit accounts). Based on data associated with the internal financial accounts and/or the external financial account, the MIPA model 210 may be configured to generate an initial user profile for the user which may be continuously modified based on the user's interactions with the MIPA model 210.

In various examples, the MIPA model 210 may be configured to retrieve, receive, extract, and/or otherwise process user data related to a user's finances, personal objectives (e.g., home ownership), life events (e.g., growing family, acquisition of pets, divorce, death of a spouse), education progression or career advancement (e.g., college graduation, career changes), and/or personal relationships (e.g., family member and peer relationships) in a variety of implicit and explicit manners. The MIPA model 210 may leverage such user data in order to continuously modify a profile of the user and/or generate one or more actionable and user-specific pathways. A pathway may be understood as a hyper-personalized actionable plan comprised of various subparts designed to assist a user in achieving a series of goals. In some examples, the MIPA model 210 may be configured to execute (in whole or in part) one or more goals, action items, operations, tasks, and/or the like on behalf of the user. Additionally or alternatively, one or more goals, action items, operations, tasks, and/or the like associated with a respective pathway may be executed (in whole or in part) by the user.

A pathway may be associated with a topic, where a topic is a category generated by the MIPA model 210 based on one or more interactions with a respective user. A topic may be an electronically managed data structure configured to store and/or compile data associated with a particular pathway. A topic may be associated with a label that summarizes a particular pathway, such as “Moving to California,” “Buying a Home,” “Early Retirement,” and/or the like. In some examples, a user may reference a topic when interacting with the MIPA model 210 (e.g., by clicking on a button in a user interface of a software application instance associated with the MIPA system 102). Additionally or alternatively, the MIPA model 210 may be configured to determine that a user is referencing a certain topic by extracting and/or interpreting various data features associated with a user interaction. For example, when a user is talking to the MIPA model 210 (e.g., by way of a smart home device), the MIPA model 210 may employ various NLP techniques to ascertain what the user is referencing and how it relates to a specific topic previously instantiated based on prior interactions with the user. In this regard, the MIPA model 210 may be configured to determine what a user is referencing during an interaction, how what the user is referencing pertains to a particular topic, and generate, store, and/or otherwise process data related to the particular topic.

A pathway associated with a respective topic may comprise various goals (e.g., primary goals such as retirement by a target age, purchasing a home), subgoals (e.g., a set of intermediate goals designed to achieve a primary goal), insights (e.g., financial outlook changes (predicted buying power improvements, predicted cost-of-living improvements in new job location), important considerations (local transit scores, housing prices), offers/programs user may qualify for (first-time home buyer programs), suggestions, recommendations), opportunities (e.g., feasible/actionable plans to achieve goals or subgoals based on current/developing financial status, “pay off high interest debt in six months”), scenarios (e.g., pathways that outline realistic impacts of user desires or wishes on established goals, “buying a vacation home”), action item lists (e.g., “could-do” lists, to-do lists), tradeoffs (e.g., potential impacts of acting on a particular goal, subgoal, opportunity, or action item), topics (e.g., categories associated with primary goals, subgoals, and/or past discussions such as “Moving to Mississippi,” “Buying a Home”) and/or the like.

In some examples, a particular pathway may be inferred by the MIPA model 210 and subsequently confirmed by the user. In other examples, a user may explicitly instruct the MIPA model 210 to generate a pathway based on a primary goal that the user already has in mind. A respective pathway may be associated with a timeline or schedule such that one or more goals (e.g., primary goals, subgoals) may be efficiently completed in sequence and/or at an optimal time. As such, a pathway may be presented to a user as a series of steps (e.g., action items) associated with a corresponding timeline. For example, a pathway may comprise a primary goal (e.g., move to Mississippi, buy a home, retire at 45 years old, and/or the like) and series of subgoals that contribute to the achievement of the primary goal (e.g., apply for first-time homebuyer tax benefits, invest in a target-date investment fund, and/or the like), where the subgoals may presented to the user in chronological order and/or in such a way that each of the subgoals correspond to a target completion date. A respective subgoal may be associated with an action item (e.g., a to-do list item) that the user is expected to complete (either in whole, or in conjunction with the MIPA model 210) in order to satisfy the respective subgoal and make progress with respect to a corresponding pathway.

In this regard, the MIPA model 210 may be configured to generate one or more action item lists. In some examples, an action item list may be associated with a particular topic and/or pathway and may be associated with one or more goals (e.g., primary goals, subgoals) linked to the particular topic and/or pathway. Additionally or alternatively, in some examples, the MIPA model 210 may be configured to generate one or more action item lists for a user that are not associated with a particular topic and/or pathway. In various examples, an action item list may be a to-do list comprising a set of action items associated with a set of subgoals designed to achieve the satisfactory completion of a primary goal upon the cumulative execution of the set of action items.

For example, if the user has had one or more interactions with the MIPA model 210 in which the user discussed (e.g., verbally and/or via text chat) the user's desire to retire by a target age (e.g., by age 55), the MIPA model 210 may generate a retirement topic and/or a pathway associated with the user's retirement. As such, the MIPA model 210 may generate an action item list configured as a to-do list comprising a series of action items configured to assist the user in achieving the primary goal of retiring by the target age. Examples of action items on such an action item list may include opening a brokerage account, funding a traditional and/or a Roth individual retirement arrangement (IRA) investment account, paying additional money towards the principal of an existing mortgage, allocating additional funds to various savings accounts, reducing expenditures associated with various spending categories, and/or the like. In some examples, a user may be prompted by the MIPA model 210 to confirm the addition of one or more action items to a respective action item list. Alternatively, in other examples, the MIPA model 210 may be configured to automatically generate and one or more action items to a respective action item list.

Additionally, in some examples, the MIPA model 210 may be configured to generate an action item list configured as a could-do list comprising various action items generated based on one or more contexts associated with a user. For example, the MIPA model 210 may be configured to generate various action items related to the potential uses for any additional or “excess” funds that have been deposited into a financial account associated with the user. For example, if the user has received funds outside of an expected amount (e.g., in addition to a known salary or income), the MIPA model 210 may generate a could-do list comprising action items related to allocating the additional funds in various ways. For example, the could-do list may comprise action items related to investing the money using an existing brokerage account associated with the user, paying off a portion of a mortgage or other expenses, using the money to complete previously instantiated goals associated with an existing pathway (e.g., retirement goals, education funding goals, residence relocation goals), instantiating a preexisting scenario into a pathway, and/or the like.

Additionally, in some examples, the MIPA model 210 may be configured to determine whose responsibility it is to complete a particular action item in a respective action item list that is associated with a respective goal (e.g., primary goal, subgoal) related to a particular topic and/or pathway. For example, the MIPA model 210 may determine that the user is solely responsible for, or indeed the only entity capable of, completing one or more tasks associated with a respective action item. Alternatively, in other examples, the MIPA model 210 may be configured to execute various action items on behalf of the user and therefore may assign the responsibility for executing such action items to the MIPA model 210 itself. Additionally or alternatively, the MIPA model 210 may assign joint responsibility to both a respective user and the MIPA model 210 itself for executing a particular action item associated with an action item list (e.g., a to-do list) related to a respective topic and/or pathway.

In this regard, in some examples, the MIPA model 210 may be configured to leverage and/or orchestrate various sub-agents 211A-211N in order to facilitate the execution of one or more action items in a respective action item list that is associated with a respective goal (e.g., primary goal, subgoal) related to a particular topic and/or pathway and/or associated with a respective opportunity identified by the MIPA model 210. As such, it will be appreciated that one or more of the operations described herein with reference to the MIPA model 210 may be executed in whole or in part by one or more respective sub-agents 211A-211N. In some such examples, a respective sub-agent of the sub-agents 211A-211N may be specially trained to execute specific tasks on behalf of a user. As such, the sub-agents 211A-211N may be configured to generate, format, and/or execute various API calls to various internal and/or external systems associated with the MIPA system 102 in order to facilitate the execution of the specific tasks.

For example, a sub-agent 211A may be configured as an account opening agent and may be enabled to open various types of financial accounts (e.g., banking accounts, investment accounts, user accounts, etc.) on behalf of a user associated with an entity (e.g., a financial institution) with which the MIPA system 102 is integrated. In such an example, the sub-agent 211A configured as an account opening agent may be given access permissions to manage and/or utilize various user data (e.g., PII, contact information, enterprise data such as data associated with one or more user accounts, and/or the like) in order to open various accounts on behalf of the user.

As another example, a sub-agent 211B may be configured as a trading and execution agent and may be enabled to execute various investment trading actions. For example, the sub-agent 211B may be configured to buy or sell various financial instruments (e.g., securities, commodities, derivative, etc.) by placing various types of orders on a financial exchange (e.g., stop-limit orders, stop-loss orders, market orders) on behalf of a user. In some such examples, the MIPA model 210 may be configured to identify various securities that may be of interest to a user based on an established pathway and present the identified securities via a user interface. If the user provides an affirmative response to a suggested trade generated by the MIPA model 210, the MIPA model 210 may cause the sub-agent 211B to be configured as a trading and execution agent to execute the suggested trade. In this regard, the MIPA model 210 and/or one or more sub-agents 211A-211N may be given access permissions to one or more user accounts (e.g., banking accounts, investment accounts, user account, etc.) in order to execute various financial transactions (e.g., account openings, security trades) on behalf of the user.

As another example, a sub-agent 211C may be configured as a money movement agent and may be enable to cause the transfer of various funds amongst two or more financial account associated with a user. For example, the sub-agent 211C configured as a money movement agent may be configured to transfer funds from a first financial account having a first account type (e.g., a checking account) to a second financial account having a second account type (e.g., a money market account, savings account, etc.). Additionally or alternatively, in some examples, the sub-agent 211C configured as a money movement agent may be configured to execute various payments on behalf of a user. For example, the sub-agent 211C may be configured to pay a bill (e.g., a utilities bill, tax bill), pay off a predetermined amount of debt (e.g., credit card debt), and/or execute one or more subscription payments to various third-party services (e.g., multimedia streaming services, e-commerce platforms, etc.).

Additionally, in some examples, the MIPA model 210 may be configured to leverage a sub-agent 211D configured as a regulatory and compliance agent which may be enabled to review one or more actions that one or more other respective sub-agents 211A-211N are attempting to execute on behalf of the user. For example, if a sub-agent 211A configured as an account opening agent attempts to open a financial account on behalf of the user, the sub-agent 211D configured as a regulatory and compliance agent may be configured to ensure that various enterprise regulations and/or standards are enforced. For example, the sub-agent 211D configured as a regulatory and compliance agent may determine whether the sub-agent 211A (or the MIPA model 210) have received explicit authorization from the user to access and/or manage the user's PII. Additionally or alternatively, the sub-agent 211D configured as a regulatory and compliance agent may be configured to ensure that various data privacy and security standards are enforced (e.g., data deletion compliance standards, user privacy compliances standards, etc.).

Additionally or alternatively, the sub-agent 211D configured as a regulatory and compliance agent may be configured to ensure that the MIPA model 210 and/or one or more sub-agents 211A-211N comply with various national and/or international rules, laws, standards, and/or guidelines set forth by one or more government agencies, regulatory bodies, and/or industry practice standardization organizations. Additionally or alternatively, the sub-agent 211D configured as a regulatory and compliance agent may be configured to enforce various guardrails associated with the entity with which the MIPA system 102 is integrated. For example, the sub-agent 211D configured as a regulatory and compliance agent may ensure that any model output generated by the MIPA model 210 and/or one or more sub-agents 211A-211N does not contain any improper bias, toxic and/or inappropriate content, and/or the like.

It will be appreciated that other types specially trained sub-agents 211A-211N may be leveraged by the MIPA model 210 to execute specific tasks during execution of the various operations described herein. As such, the foregoing example sub-agents described herein have been provided for purposes of explanation and are not included to limit the spirit or the scope of the present disclosure.

The MIPA model 210 may be configured to determine if a respective action item associated with a particular action item list has been completed in a number of ways. In some examples, a user may indicate to the MIPA model 210 that the user has executed (e.g., completed) the action item. Additionally or alternatively, the MIPA model 210 may be configured to track the progress and/or status of a respective action item associated with a particular action item list. For example, if the completion of an action item is dependent on the submission of various documentation to a particular recipient (e.g., loan application documentation, tax documentation, credit line application documentation, user identification documentation, and/or the like), the MIPA model 210 may be configured to await an acknowledgement (e.g., a digital signature, a digital token, a data object, a receipt document) generated by the recipient that indicates that the recipient has successfully received the documentation.

In some examples, the MIPA model 210 may be configured to cause the automatic transmission of such various documentation on the behalf of the user and, as such, may be configured to receive any acknowledgements generated by the recipient of the documentation (e.g., a third-party enterprise, organization, business, institution, individual, and/or the like). In some examples, if the user receives a digital acknowledgement (e.g., (e.g., a digital signature, a digital token, a data object) from a recipient on a user device associated with the user (e.g., a smartphone, a laptop), the MIPA model 210 may be configured to automatically receive and/or retrieve said digital acknowledgement from the user device. Additionally, in examples in which the user submits various documentation to a respective recipient (e.g., electronically or by mail), the user may be enabled to upload various acknowledgment data to the MIPA model 210 manually (e.g., by uploading digital correspondence via the software application instance associated with the MIPA system 102). Once the MIPA model 210 has determined that a particular action item associated with a respective action item list has been executed (in whole by the user and/or in conjunction with the MIPA model 210), the MIPA model 210 may flag the action item, move the action item to a completed action item collection (e.g., a completed action item list), and/or otherwise indicate to the user that the respective action item has been satisfactorily completed.

In addition to generating respective pathways and corresponding action item lists associated with various goals associated with the respective pathways, the MIPA model 210 may be configured to generate a scenario for a user based on one or more interactions with the user. A scenario may differ from a pathway in that a scenario may be associated with a secondary goal (e.g., an idea, desire, wish, daydream) that the user wishes to leverage the MIPA model 210 to explore. A scenario is different than a user-confirmed goal (e.g., different than a primary goal and/or subgoal, action item, or the like) associated with an established pathway. For example, a scenario may be associated with the user's desire to one day purchase a real estate investment property for personal user and/or as a passive income vehicle. In this regard, the MIPA model 210 may be configured to provide pathways (e.g., actionable plans) related to a scenario based on the preexisting context of instantiated goals (e.g., instantiated primary goals and/or subgoals).

As such, the MIPA model 210 may be configured to present various potential tradeoffs that may be incurred as a result of pursuing one or more goals associated with a scenario. For example, the MIPA model 210 may be configured to indicate that the user may be able to purchase a real estate investment property, but that purchasing the real estate investment property will adversely affect the user's progress towards various established goals (e.g., established educational savings goals, established retirement goals, and/or the like). In some examples, the MIPA model 210 may be configured to indicate such tradeoffs to the user audibly (e.g., by leveraging an integrated speech model), textually (e.g., by leveraging various NLP techniques), and/or visually (e.g., using various graphs and charts).

Furthermore, the MIPA model 210 may be configured to determine a user's sincerity regarding a particular scenario. For example, if the user consistently references a first scenario (e.g., purchasing a real estate investment property) more often than a second scenario (e.g., purchasing a classic car), the MIPA model 210 may assign a relatively higher sincerity weight to the first scenario (e.g., a numerical value indicating an inferred level of sincerity or intent). In some examples, based on the sincerity weight associated with a particular scenario, the MIPA model 210 may prompt the user to determine if the user wishes to convert the scenario into a pathway (e.g., instantiate one or more goals for acquiring a real estate investment property).

Additionally, the MIPA model 210 may be configured to clarify the nuance of user's desire related to a particular scenario. For instance, if a user consistently references purchasing a real estate investment property in a particular location (e.g., the Miami, Florida beachfront), the MIPA model 210 may be configured to determine whether that is a realistic goal or whether an alternative, yet similar goal may be achievable. For example, the MIPA model 210 may be configured to leverage data (e.g., real estate data, cost-of-living data, and/or the like) related to other locations that may be of interest to the user and/or that may be a better fit for the user based on their current financial status (e.g., more affordable). In such an example, the MIPA model 210 may be configured to generate model output (e.g., audio output, textual output, and/or visual output) such as, “I understand you may be interested in a beach house as an investment property. Miami investment properties are currently out of reach based on your current financial situation, but have you considered lakefront property in Wisconsin? I have located a few properties that may interest you . . . ” In this regard, the MIPA model 210 may be configured to suggest alternative opportunities related to a scenario that a user consistently references that the user may not have previously considered.

In various examples, one or more scenarios generated by the MIPA model 210 based on various user interactions may be stored and then accessed again in the future based on the user's current financial status. For example, if the MIPA model 210 determines that a user has experienced a windfall (e.g., an unexpected inheritance) or a receives a substantial raise or bonus (e.g., based on the user's financial account data), the MIPA model 210 may be configured to re-run (e.g., re-process) a particular scenario for the user. In such an examples, the MIPA model 210 may be configured to generate model output (e.g., audio output, textual output, and/or visual output) such as, “Are you still interested in buying an investment property? Based on your current financial profile you may be able to make a down payment towards a property in Florida. I have identified a few recent listings. Are you interested in seeing them?” In such an example, if the user provides an affirmative response (e.g., clicking a button in a user interface of a software application instance associated with the MIPA system 102, saying “yes”, or giving a “thumbs up” gesture in view of a camera associated with a smart home device), the MIPA model 210 may be configured to provide data related to the real estate listings in numerous ways including providing the user with hyperlinks to various websites, displaying images of the real estate listing on a smart home device and/or a user device (e.g., a smartphone), and/or sending various data, documentation, and/or the like to the user's email account.

As described herein, the MIPA model 210 may be configured to gather data (e.g., user data, external data) that is relevant to a user in various explicit and/or implicit ways. In various examples, the MIPA system 102 may be configured to enable a user to opt-in and grant various access permissions to the MIPA model 210. In this regard, the MIPA model 210 may be configured to access various accounts associated with a user in order to obtain various data associated with the user. For example, the MIPA model 210 may be configured to access one or more of an email account, financial account (e.g., banking account, credit account, investment account), user account associated with various enterprises (e.g., financial institutions, businesses, organizations), social media account, and/or the like.

Additionally or alternatively, the user may be enabled to grant access permissions associated with one or more computing devices to the MIPA model 210. For example, the user may grant access to one or more of a user device (e.g., a user device 108A such as a smartphone, laptop, tablet computer), a smart home device (e.g., virtual assistant device), a home automation system device, Internet of Things (IoT) devices (e.g., network-capable appliances), and/or the like. As such, the MIPA model 210 may be configured to receive, retrieve, compile, aggregate, and/or otherwise manage data associated with one or more accounts and/or one or more computing devices associated with a respective user. Additionally, the MIPA model 210 may be configured to execute various computer program code related to the management, functionality, and/or operation of one or more accounts and/or computing devices associated with the user.

Additionally, in some examples, a software application instance (e.g., a mobile app) associated with the MIPA system 102 may enable the MIPA model 210 to ingest user data explicitly by enabling a user to scan physical documents (e.g., paper correspondence) and/or submit electronic documents (e.g., digital correspondence, emails) so that the MIPA model 210 can analyze the physical and/or electronic documents, extract various data features, and/or determine the subject matter of the physical and/or electronic documents.

Additionally, the MIPA model 210 may be configured to ingest user data implicitly in a number of ways. For example, the MIPA model 210 may be configured to utilize various device data associated with a user device (e.g., user device 108A) associated with a respective user including image data, location data (e.g., GPS coordinate data), social media data, shopping data (e.g., wish list data), and/or the like to determine a user's financial goals, desires, objectives, and potential opportunities. For example, the MIPA model 210 may detect that a user is currently located at a wedding dress shop based on location data (e.g., GPS coordinate data), timestamp data, and/or image data from the user's camera roll and determine that the user is shopping for wedding dress or formal attire. As such, the MIPA model 210 may instantiate various pathways goals (e.g., primary goals, subgoals), action items, and/or opportunities based on the fact the user is wedding dress shopping. In such an example, the MIPA model 210 may prompt the user in direct and/or indirect ways to determine whether the user themself is getting married or if the user is to be included in a wedding party or attending a formal event. Based on the user's response, the MIPA model 210 may generate and/or adjust various topics, goals (e.g., primary goals, subgoals), opportunities, and/or the like accordingly.

Additionally, the MIPA model 210 may be configured to ingest user data implicitly from a user via one or more conversational interactions (e.g., when the user is speaking to the MIPA model 210, when the user is typing to the MIPA model 210 in a chat-based interaction). Furthermore, the MIPA model 210 may be configured to gather user data using conversational segues. A conversational segue may be a prompt (e.g., a follow-up question, an insight, an acknowledgement) provided by the MIPA model 210 to a user in response to a user's input (e.g., a user's comment or question). A conversational segue may be configured to solicit an additional response from the user and glean additional information. For example, if a user tells the MIPA model 210 they have adopted a dog, the MIPA model 210 may use a conversational segue to prompt the user to disclose what breed of dog the user has adopted in order to determine how the particular breed may impact any established goals (e.g., primary goals, subgoals) associated with the user. As another example, the MIPA model 210 may prompt a user to clarify previous information obtained during prior conversations. For instance, if a user has provided an estimate of their average monthly or annual spending amount (e.g., during a previous interaction), the MIPA model 210 may prompt the user with a conversational segue to clarify if the estimate includes various other sources of spending, debt payments, and/or the like.

The MIPA model 210 may also employ conversational segues in order to reengage the user with previously discussed topics (e.g., a future move, career change, goal, and/or the like about which the MIPA model 210 may require additional data from the user). For example, if the user engages the MIPA model 210 related to investing money into an IRA investment account for the year, the MIPA model 210 may prompt the user regarding a prior conversation related to opening an education savings account for their child to determine if the user is still interested in opening the account (e.g., “After you fund your IRA for the year you'll have a remaining balance of $XX.XX, are you still interesting in opening a 529 education account for Billy?”). As such, a conversational segue may be associated with a tangential subject that is not necessarily central to a current interaction taking place with the user.

The MIPA model 210 may also be configured to leverage the user data circuitry 212 to retrieve various enterprise data associated with the user, where enterprise data may be related to various existing account data (e.g., account balances, expenditures), account beneficiary data, financial history data (e.g., credit history, transaction history, salary history), user profile data, and/or the like associated with an enterprise that employs the MIPA model 210. In some examples, ingestion of such data by the MIPA model 210 may occur without direct interaction or awareness on the part of the user and may be utilized to generate and/or continuously update an initial user profile associated with the user.

Additionally, in some examples, the MIPA model 210 may be configured to leverage the external data circuitry 214 to retrieve external data (e.g., legislative data, tax data, real estate data, financial data, market data, cost-of-living data, news and event data, product data, product offer data) from a variety of external sources. For example, the MIPA model 210 may leverage the external data circuitry 214 to ingest or otherwise take into account legislative data (e.g., tax legislation data) and/or current events that may impact a user while generating and/or modifying pathways for the user. For example, if the user is planning a move to another state, the MIPA model 210 may take into account any federal-, state-, and/or county-level legislation that may affect user (e.g., cost-of-living impacts and/or opportunities that may assist in achieving various subgoals associated with the user's established pathways). Furthermore, the MIPA model 210 may be configured to leverage the external data circuitry 214 to query various third-party enterprises (e.g., third-party financial institutions) to obtain user data associated with the user, peer group data associated with the user's peer group (e.g., users associated with a same or similar income level, tax bracket, financial status, occupation, demographic, educational background, cost-of-living location), and/or data that may impact the established pathways of the user.

In addition to ingesting user data and/or external data that may impact the user's various established pathways, opportunities and the like, the MIPA model 210 may be configured to intelligently infer data associated with the user. In this regard, the MIPA model 210 may be configured to determine any “gaps” in the user's data (e.g., a set of missing user data in the user data associated with a profile or a nascent profile associated with the user). In some examples, the MIPA model 210 may be configured to fill in gaps in the user data by inferring user data and instantiating the inferred user data for the user based on various peer group data associated with the user's peer group. In some examples, missing user data may also be inferred from logged user interaction data associated with similar users that also actively engage with the MIPA model 210. For example, the MIPA model 210 may generate goals (e.g., primary goals, subgoals), insights, and/or the like for the user based on similar goals (e.g., primary goals, subgoals), insights, and/or the like that were acted upon by other users in a same or similar situation.

In this regard, the MIPA model 210 may be configured to prompt a user asking if the user is comfortable with the MIPA model 210 “guessing” (e.g., making data-driven inferences or predictions) about the user and/or any missing information about the user. For example, the MIPA model 210 may guess (e.g., infer, predict) that the user makes a certain annual salary based on various deposit history associated with a payment account of the user. As such, the MIPA model 210 may use any inferred data to modify a user profile and/or one or more pathways associated with the user. In some embodiments, the MIPA model 210 may periodically prompt the user to explain various inferences that it has made about the user and allow the user to confirm or update any information related to the inferences it has made.

The MIPA model 210 may also be configured to intentionally guess wrong about certain user data and present the incorrect user data to the user in order to solicit a response from the user (e.g., solicited user input). For example, the MIPA model 210 may intentionally provide the user with intentionally incorrect user data comprising under- or over-estimations related to the user's data (e.g., under-estimations related to the user's inferred salary, savings, spending) so that the user feels compelled to correct the MIPA model 210 with accurate information. In practice, the MIPA model 210 may be able to determine accurate inferences and/or estimations related to the user's data (to within an acceptable confidence level or tolerance, e.g., ±2%, ±5%, or any other predefined margin) and then make a decision to over- or under-estimate said accurate inferences and/or estimations when presenting the incorrect information to user in order to solicit a response (e.g., a user generated correction regarding the intentionally over- or under-estimated inferences or estimations). In various examples, the MIPA model 210 may be configured to learn over time by what percentage the MIPA model 210 should over- or under-estimate certain data related to the accurate inferences (e.g., ±2%, ±5%, or any other suitable margin over or under a value associated with the accurate inferences/estimations).

Additionally, the MIPA model 210 may be configured to infer character traits about user based on various inputs provided by the user (e.g., inputs related to action items and/or pathways acted upon by the user, conversational data input by the user, interactions with a software application instance associated with the MIPA model 210, and/or the like). Such inferred character traits may be utilized by the MIPA model 210 to influence future pathway suggestions (e.g., primary goal and/or subgoal suggestions, action item suggestions, opportunity suggestions, and/or the like) made by the MIPA model 210 over time. For example, the MIPA model 210 may determine that a respective user repeatedly chooses and/or acts upon debt-averse goals (e.g., primary goals, subgoals), opportunities, action items, and/or the like when multiple choices (e.g., multiple opportunities) are presented to the user.

In such examples, the MIPA model 210 may heavily weight debt-averse options when presenting choices to the user in the future. In this manner, the MIPA model 210 may be able to determine various character traits associated with the user (e.g., conservative, frugal, spendthrift, risk-averse, debt-averse, bold, risky, patient, eager, compulsive, tech-savvy, and/or the like). Additionally, the MIPA model 210 may be configured to generate and/or update a risk tolerance profile associated with the user that defines a user's appetite for risk regarding various financial and/or personal pathways. For example, the MIPA model 210 may determine that the user is comfortable investing in an aggressive stock portfolio, yet the user prioritizes living within modest means, paying down high interest debts, and/or paying extra principal on loans, and/or the like with any “excess” funds or additional funds they may have outside their usual budget (e.g., extra monthly income, tax returns, dividend disbursements).

While the MIPA model 210 may be configured to interact with a user in a variety of ways (e.g., via a web browser, smart home device, user device), user interaction with the MIPA model 210 may be provided via a software application instance (e.g., a mobile application) associated with the MIPA system 102. In this regard, the MIPA model 210 may be configured to generate, manage, and/or otherwise integrate with various modules and/or financial outlook tools associated with a software application instance that may be accessed by a user device (e.g., a user device 108A configured as a mobile phone, laptop computer, and/or the like) associated with a respective user. In such examples, the MIPA model 210 may present model output (e.g., audio output, textual output, and/or visual output) related to various opportunities and/or action items configured to enable a user to complete one or more subgoals associated with a respective topic and/or pathway. For example, the MIPA model 210 may leverage generative AI and/or NLP techniques to present various opportunities to a user in a conversational manner (e.g., as text-based chat output, and/or synthetic speech output).

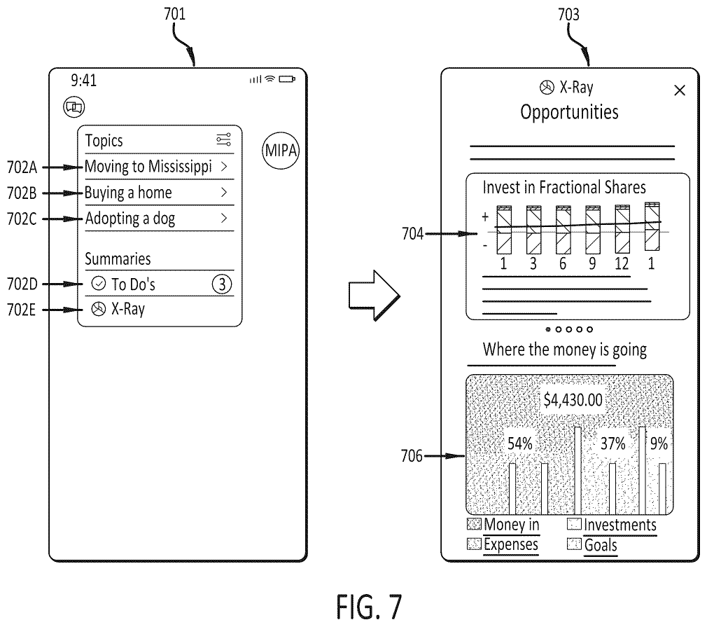

For example, the MIPA model 210 may integrate with a financial status “X-ray” tool configured to analyze a user's current financial status. The financial status X-ray tool may be a software-based module integrated with the software application instance associated with the MIPA system 102. The financial status X-ray tool may be configured to aggregate, compile, and/or analyze various financial data associated with the user (e.g., data related to banks accounts, transaction history, deposit history, investment portfolio performance, investment dividends, beneficiary data, credit data, mortgage data, debt data) from various internal and external sources to determine the user's current financial status. As such, the financial status X-ray tool may be configured to generate one or more digital representations (e.g., graphs, charts, images) related to the intake and expenditure of the user's money. Additionally, the financial status X-ray tool may categorize and/or classify certain funds in order to inform the user where their money is coming from (e.g., salary, dividends) and/or being allocated to (e.g., expenses, debt, investments, goals). Further details related to the implementation of the financial status X-ray tool will be described herein with reference to FIG. 7.

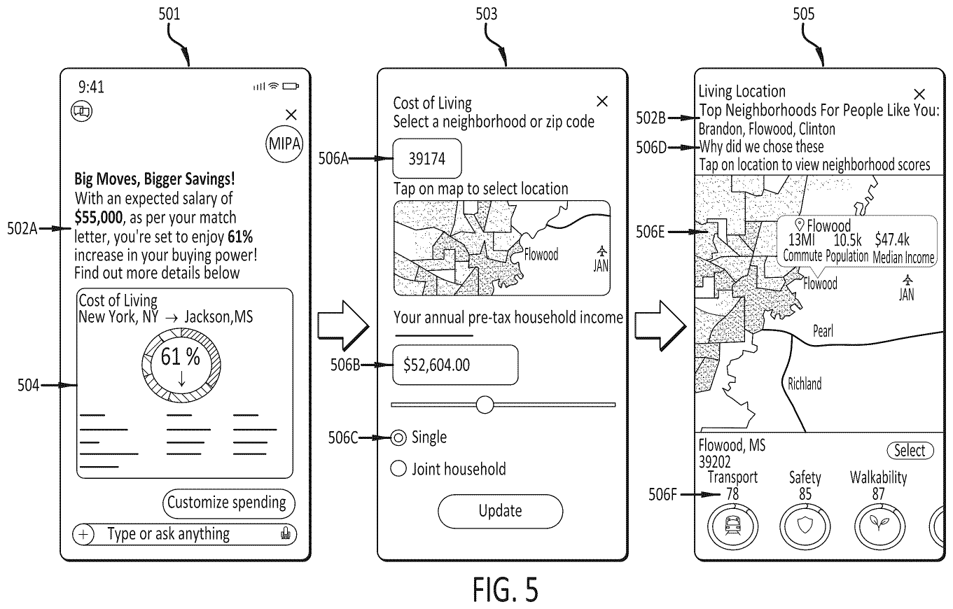

In addition to the financial status X-ray tool, the MIPA model 210 may be configured integrate with a cost-of-living impact tool. The cost-of-living impact tool may be a software-based module integrated with the software application instance associated with the MIPA system 102. The cost-of-living impact tool may be configured to analyze and provide data related to various benefits and/or disadvantages relative to a first living location (e.g., a geolocation, city, neighborhood, county, and/or the like where the user currently lives) versus a second living location (e.g., a geolocation, city, neighborhood, county, and/or the like to which the user may relocate). The MIPA model 210 may provide data related to such benefits and/or disadvantages associated with the first and second living locations based on the current and/or future (e.g., inferred, predicted) financial status of the user. Such a cost-of-living impact tool may be beneficial to a user taking a new job in a new living location and may help the user account for issues related to the move that they may have not previously considered. Further details related to the implementation of the cost-of-living impact tool will be described herein with reference to FIG. 5.

As described herein, a respective MIPA model 210 associated with a particular user may be configured such that no manual configuration is required from the user upon the setup, initialization, or initial configuration of the respective MIPA model 210. Instead, the MIPA model 210 may generate an initial user profile or account on the backend by aggregating enterprise data and/or user data from multiple sources. For example, data associated with a respective user (e.g., user data, enterprise data) may be collected from one or more enterprises associated with the user and may include financial transaction history data, financial account balance data, PII, demographic information, behavioral data (e.g., online banking activity, data associated with enterprise branch visits, data associated with user interactions with customer service individuals and/or enterprise-managed chatbots), credit history data, cost-of-living data, social media data, and/or the like associated with the user. Such data may be processed by the MIPA model 210 and transformed into meaningful features related to the various methods described herein.

Using such data, a suite of ML models that may be leveraged by the MIPA model 210 may be established including one or more predictive models (e.g., to predict future user behavior), descriptive models (e.g., to summarize the customer and cluster with similar users), and/or prescriptive models (e.g., to make recommendations, suggestions, and/or present opportunities). The MIPA model 210 may then reference these models in future interactions with the user to determine how to respond and/or what actions to take on behalf of the user. The user data and the models developed from the user data may be automatically recalibrated over time (e.g., updated or retrained) based on additional user interactions. In some examples, clustered output of a descriptive model may be used to further drive the establishment of the initial user profile through filling in gaps of the user's profile with information of similar users associated with the user's peer group.

In some examples, the MIPA model 210 may provide a modularized and/or tailored means to attain additional information for a user profile. This may include, for example, a modular “setup wizard” component that enables a user to enter data manually (e.g., if the user so chooses). In some examples, this may include one or a series of prompts that enable the user to communicate various information to the MIPA model 210 in a conversational format (e.g., via verbal speech, direct chat in a software application instance associated with the MIPA system 102, and/or the like). This functionality may occur based on interactions with the user, such as, for example, when a new topic comes up in conversation for which the MIPA model 210 has little to no information on.

In some examples, the MIPA model 210 may provide a method of “going back in time,” resetting, or updating various user data and/or data associated with established topics and/or pathways. As such, a respective user may be enabled to reconfigure the MIPA model 210 based on new data points. For example, the MIPA model 210 may be reverted to an earlier state based on various significant life events that have occurred with respect to the user. The MIPA model 210 may also be reverted (e.g., reconfigured, updated, reset) based on a shift in a user's mindset, goals, and/or outlook (e.g., financial outlook, financial status). In some embodiments, users may be enabled to initiate a reversion, resetting, and/or reconfiguration of the MIPA model 210 based on one or more interactions with the MIPA model 210 and/or a software application instance associated with the MIPA system 102. In some embodiments, the MIPA model 210 may be configured to make a determination on whether to reset and/or recalibrate on the backend without receiving any input from the user. As one example, the MIPA model 210 may recognize instances in which a user is going through a divorce, and this may involve substantial changes to the user's financial outlook and/or financial status (e.g., as a result of splitting financial accounts, making required alimony payments, and/or the like), as well as substantial changes to one or more established pathways associated with the user.

Additionally, the MIPA model 210 may be configured to continuously evaluate user goals and any progress made towards completing those goals based on certain triggers. These triggers may include, in some examples, financial events such as mortgage payments (e.g., interest, principal, and/or escrow payments), credit card and/or other debt instrument payments, receipt of earned dividends (e.g., investment dividends), receipt of income (e.g., salary income, investment income, windfall income), receipt of government disbursements (e.g., tax refunds), new account openings, new loan openings. Additionally or alternatively, in some examples, a trigger may be associated with various behavioral events (and not strictly financial), such as travel-related bookings (e.g., hotel bookings, flight purchases, transit purchases), user device location data (e.g., GPS coordinate data indicating the user is not in a typical location), social media data (e.g., a user post and/or response related to various social media content), and/or the like. For example, the MIPA model 210 may recognize when a user may not be keeping track with an established goal (e.g., an established primary goal and/or subgoal) of paying off their primary residence mortgage early. For instance, the MIPA model 210 may determine that a respective mortgage payment is made by the user without any additional payment made towards the principal of the mortgage loan. Similarly, the MIPA model 210 may recognize that an established savings goal may be impacted based on various travel-related bookings (e.g., vacation expenditures) made by the user.

Additionally, in various examples, the MIPA model 210 may periodically “check in” with a respective user to assess and/or confirm that the MIPA model 210 correctly understands the user and/or the user's goals, objectives, interests, life events, and/or the like. These check-ins may be initiated by the MIPA model 210 in view of recently detected events or in some examples may be user initiated. A check-in may be configured as one or more prompts designed to confirm an understanding of the user's goals, objectives, interests, life events, and/or the like, and may be configured as audio, textual, and/or visual model output. In some examples, a user may be enabled to ask the MIPA model 210 what the MIPA model 210 knows and/or has inferred about the user. For example, a user may provide input (e.g., text-based input and/or speech input) such as, “Tell me what you think of me.” In response to such a query, the MIPA model 210 may be configured to generate and provide various model output that describes a general overview of the user and/or the user's goals. In such an example, the user may be enabled to confirm, deny, and/or update various data that has been cataloged, inferred, predicted, and/or otherwise generated by the MIPA model 210 whenever the MIPA model 210 provides such data to the user.

In various examples, the MIPA model 210 may initiate a check-in with a respective user in response to the submission of various documentation to the MIPA system 102 by the respective user. For example, as described herein, a user may be enabled to leverage a software application instance associated with the MIPA system 102 to submit various documentation including correspondence (e.g., digital correspondence such as email, and/or scanned copies of physical correspondence), technical documentation, legal documentation, and/or the like for the MIPA model 210 to process. For example, if a user submits a college acceptance letter the MIPA model 210 may be configured to check in with the user to determine whether the user will be attending the corresponding university or if the user has received any other acceptance letters.

Accordingly, the MIPA model 210 may be configured to generate various suggested pathways, goals, opportunities, insights, and/or the like based on any data gained in response to such a check in. For example, the MIPA model 210 may be configured to extract various data features related to a respective university's programs, administration personnel, scholarship opportunities, tuition, academic calendar, and/or the like from a respective acceptance letter. Additionally or alternatively, the MIPA model 210 may be configured to query various server systems associated with the respective university to obtain additional data that was not provided by the respective acceptance letter and present the additional data to the user.

In some examples, the MIPA model 210 may deliver prompts, responses, data and/or information to a user in a text-based manner (e.g., via SMS and/or email, via a user interface, and/or the like), in a visual manner (e.g., via visual graphics rendered on a user interface), in an audible manner (e.g., via automated speech), or via combination of text, graphics, and audio. In some examples, the MIPA model 210 may determine the means in which information is to be provided to a user based on the manner in which user input is received from and/or prepared by the user. For example, the MIPA model 210 may process user input (e.g., text input or speech input) using text or voice sentiment analysis. Based on such text or voice sentiment analysis, the MIPA model 210 may determine a manner in which to provide a response to the user. For example, if a user asks a detailed, technical question that includes technical or financial terms that coincide with terminology used by experts in the field, the MIPA model 210 may provide a detailed, technical response. Similarly, if a user were to ask a simple, brief question, the MIPA model 210 may format a response (e.g., text-based or audio-based model output) to be brief as well.

In some examples, due to the distributed nature of computing devices a user may possess (e.g., smart home devices, laptops, smartphone), the MIPA model 210 may determine an appropriate means to communicate with the user based on the nature of a user's question and/or how much detail needs to be presented to the user. For instance, in the event the user provides user input such as a technical question (e.g., via a smartphone) that warrants a lengthy response and/or explanation, the MIPA model 210 may generate and email a transcript of a model response to the user rather than produce an audible reply that may take several minutes to read aloud. Furthermore, the MIPA model 210 may be configured to notify the user (e.g., via an audible voice prompt, an SMS message, and/or the like) that an email has been sent to an email account associated with the user. In such an example, the MIPA model 210 may also ask if the user wishes to hear the voice reply associated with the emailed response and/or explanation if it is more convenient for the user in that moment (e.g., if the user is currently driving a car).

In this regard and as described herein, any information ingested by the MIPA model 210 via a first computing device (e.g., via a smart home device, or laptop utilizing a web browser) may be processed on the backend to provide a continuous user experience, and may enable a user who interacted previously with the MIPA model 210 via the first device (e.g., via a smart home device, or laptop utilizing a web browser) to pick up where the user left off via a second computing device (e.g., a user device 108A utilizing a software application instance associated with the MIPA system 102, and/or the like) at a later time.

Additionally, in some examples, the MIPA system 102 may be configured to monitor a given session associated with the interaction of a respective user with a software application associated with the MIPA system 102 to generate a session navigation context. For example, the MIPA management circuitry 208 may log and store one or more navigation steps a user executes with respect to the various components of the software application instance associated with the MIPA system 102. In some such examples, once a user has been successfully authenticated and a user has been given access to a software application framework associated with the entity integrated with the MIPA system 102 (e.g., a financial institution), each action the user takes subsequent to logging in may be aggregated into a session navigation context. An example session navigation context may describe or otherwise indicate which webpages (e.g., user account pages, webpages associated with an enterprise) have been accessed, which web application components have been utilized (e.g., tools, interactive user interface elements), web-based services (e.g., online banking services), and/or the like that a user has used and/or navigated to during a respective session. In some examples, each navigation step or discrete action that a user executes with respect to the software application instance may be logged in the session navigation context with accompanying timestamp data.

The session navigation context may be provided to the MIPA model 210 as contextual model input data. In some examples, the MIPA model 210 may determine the intent of a particular session based on the session navigation context. For example, the MIPA model 210 may determine that a user's intent is to transfer money between multiple financials accounts, to make a trade with respect to an existing brokerage portfolio, to open a new type of account, and/or the like. Additionally, the MIPA model 210 may be configured to generate and/or provide one or more opportunities to the user based on the inferred intent of the user. For example, if the MIPA model 210 infers, based on the session navigation context, that the intent of the user is to compare interest rates of various financial accounts, the MIPA model 210 may identify a particular financial account type (e.g., a CD with a higher return rate relative to the user's current savings account) and present the identified financial account to the user.

In such an example, the MIPA model 210 may be configured to provide data related to an identified opportunity according to the current context of the software application instance (e.g., within a webpage detailing the various accounts offered by the entity integrated with the MIPA system 102). For example, the user may have navigated to a particular location within the software application instance and away from an interactive chat window associated with the MIPA model 210. However, because the MIPA model 210 may be configured to track the interactions of the user based on the session navigation context, the MIPA model 210 may be configured to cause the software application instance to embed relevant, model-generated information (e.g., data related to various identified opportunities, progress related to established pathway goals, etc.) in specific locations within the software application instance. Additionally or alternatively, the MIPA model 210 may be configured to cause the expansion of various popup windows, interactive chat windows, and/or various other interactive user interface elements based on the session navigation context. This provides the benefit of enabling the user to engage with MIPA model 210 and/or the data generated by the MIPA model 210 (e.g., opportunity data, pathway progress data, data related to various inferred goals, data related to various topics, etc.) without having to navigate to (or navigate back and forth from) a dedicated interactive chat window associated with the MIPA model 210. In this manner, the MIPA system 102 may save computational resources and/or mitigate adverse impacts and inefficiencies in the user experience by removing the need to navigate back and forth from a dedicated interactive chat window associated with the MIPA model 210.

Additionally, in some examples, the MIPA model 210 may utilize the session navigation context to dynamically determine when to initiate a check-in interaction with the user. For example, if the user has navigated to a savings account page within the software application instance, the MIPA model 210 may initiate a check-in interaction to summarize the progress the user has made towards an established savings goal associated with a particular pathway. As described herein, a user check-in may be configured as one or more prompts designed to confirm an understanding of the user's goals, objectives, interests, life events, and/or the like, and may be configured as audio, textual, and/or visual model output.

The apparatus 200 further comprises user data circuitry 212. In some examples, the user data circuitry 212 may be configured to facilitate the execution of one or more user data retrieval, user data reception, user data storage, user data management, and/or user data processing operations for the MIPA system 102. As such, the user data circuitry 212 may utilize the communications hardware 206 to gather data from, or transmit data to, a variety of sources (e.g., the enterprise computing devices 106A-106N, the user devices 108A-108N, social media networks, consumer banking servers, third-party server systems, and/or any storage devices (e.g., storage device 110) associated with the MIPA system 102), and/or exchange data with a respective user. In some examples, the user data circuitry 212 may be configured to manage data associated with the enterprise utilizing the MIPA system 102 such as, for example, data related to one or more users associated with the enterprise and/or one or more products, services, and/or personnel associated with the enterprise. Additionally, the user data circuitry 212 may utilize the processor 202, the memory 204, the MIPA management circuitry 208, the external data circuitry 214, and/or any other hardware component associated with the apparatus 200 to perform these operations, as described in connection with FIGS. 3-13 below.

Furthermore, in various examples, the user data circuitry 212 may be configured to leverage the processor 202, the memory 204, the communications hardware 206, the MIPA management circuitry 208, and/or the external data circuitry 214 to retrieve, receive, collate, compile, aggregate, store, and/or otherwise manage data related to one or more topics, pathways, goals (e.g., primary goals, subgoals), insights, opportunities, scenarios, action item lists, tradeoffs, and/or any data related to model output generated by the MIPA model 210 for a respective user. Additionally, the user data circuitry 212 may be configured to retrieve, receive, collate, compile, aggregate, store, and/or otherwise manage data related to any user input provided by the user during one or more interactions with the MIPA model 210. For example, the user data circuitry 212 may be configured to manage various user input related to one or more text data streams, audio data streams, and/or video data streams associated with various user input provided during one or more interactions with the MIPA model 210.

In addition, the apparatus 200 further comprises external data circuitry 214. In some examples, the external data circuitry 214 may be configured to facilitate the execution of one or more enterprise data retrieval, reception, storage, management, and/or processing operations for the MIPA system 102. As such, the external data circuitry 214 may utilize the communications hardware 206 to gather data from, or transmit data to, a variety of sources (e.g., the enterprise computing devices 106A-106N, the user devices 108A-108N, consumer banking servers, third-party server systems, and/or any storage devices (e.g., storage device 110) associated with the MIPA system 102), and/or exchange data with a respective user. Additionally, the external data circuitry 214 may utilize the processor 202, the memory 204, the MIPA management circuitry 208, the user data circuitry 212, and/or any other hardware component associated with the apparatus 200 to perform these operations, as described in connection with FIGS. 3-13 below.

Furthermore, in various examples, the external data circuitry 214 may be configured to leverage the processor 202, the memory 204, the communications hardware 206, the MIPA management circuitry 208, and/or the user data circuitry 212 to retrieve, receive, collate, compile, aggregate, store, and/or otherwise manage data related to various enterprise accounts (e.g., financial accounts, government accounts, authoritative entities). Additionally, the external data circuitry 214 may be configured to retrieve, receive, collate, compile, aggregate, store, and/or otherwise manage third-party data associated with various external institutions, organizations, businesses, governmental agencies, and/or the like. For example, the MIPA model 210 may be configured to leverage the external data circuitry 214 to retrieve and/or process data related to legislation (e.g., tax legislation, local law, federal law), living location data, peer group data, news and current events data, and/or the like.

Although components 202-214 are described in part using functional language, it will be understood that the particular implementations necessarily include the use of particular hardware. It should also be understood that certain of these components 202-214 may include similar or common hardware. For example, the MIPA model 210, the user data circuitry 212, and/or the external data circuitry 214 may each at times leverage use of the processor 202, memory 204, and/or communications hardware 206, such that duplicate hardware is not required to facilitate operation of these physical elements of the apparatus 200 (although dedicated hardware elements may be used for any of these components in some examples, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some examples, the term “circuitry” may, in addition, refer to software instructions that configure the hardware components of the apparatus 200 to perform the various functions described herein.

Although the MIPA management circuitry 208, the MIPA model 210, the user data circuitry 212, and/or the external data circuitry 214 may leverage processor 202, memory 204, and/or communications hardware 206 as described above, it will be understood that any of the MIPA model 210, the user data circuitry 212, and/or the external data circuitry 214 may include one or more dedicated processors, specially configured field programmable gate arrays (FPGA), or application specific interface circuits (ASIC) to perform its corresponding functions, and may accordingly leverage processor 202 for executing software stored in a memory (e.g., memory 204), or communications hardware 206 for enabling any functions not performed by special-purpose hardware. In all examples, however, it will be understood that the MIPA model 210, the user data circuitry 212, and/or the external data circuitry 214 comprise particular machinery designed for performing the functions described herein in connection with such elements of apparatus 200.

In some examples, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, examples contemplated herein may be implemented by an apparatus 200. Furthermore, some examples may take the form of a computer program product comprising software instructions stored on at least one non-transitory computer-readable storage medium (e.g., memory 204). Any suitable non-transitory computer-readable storage medium may be utilized in such examples, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of an example apparatus 200, operational examples as well as example operations are described below in connection with a series of illustrations and flowcharts.

### Operational Examples

Turning to FIGS. 3-8, operational examples of a software application instance associated with the MIPA system 102 are provided. The examples provided in FIGS. 3-8 illustrate various example user interfaces, example user interactions, and example model output generated by the MIPA model 210, as well as example executions of various methods described herein. It will be appreciated that certain functionalities and potential use cases associated with the MIPA system 102 as described herein are not illustrated in FIGS. 3-8, or may not be illustrated in full, and that additional examples, use cases, embodiments, configurations, layouts, and/or user experiences may come to mind for persons of ordinary skill in the art. Accordingly, the examples illustrated in FIGS. 3-8 are provided herein for the purposes of explanation of various methods described herein, and not for the purposes of limiting the scope or spirit of the present disclosure.

FIG. 3 illustrates example user interfaces of an example software application instance integrated with the MIPA model 210 configured to provide MIPA in accordance with some examples described herein. Specifically, FIG. 3 illustrates a use case in which the MIPA model 210 may be configured to obtain and/or process user data associated with a user based on documentation submitted by the user. As described herein, a software application instance (e.g., a mobile app) associated with the MIPA system 102 may allow the MIPA model 210 to ingest user data explicitly by enabling a user to scan physical documents (e.g., paper correspondence) and/or submit electronic documents (e.g., digital correspondence, emails) using a user device (e.g., user device 108A) so that the MIPA model 210 can analyze the physical and/or electronic documents, extract various data features the physical and/or electronic documents, and/or determine the subject matter of the physical and/or electronic documents.

For example, as shown by user interface 301, a user may employ the software application instance associated with the MIPA system 102 to submit digital correspondence 304 to the MIPA model 210, where the digital correspondence 304 is an email related to the user's acceptance to a medical residency program in another state or province (e.g., the University of Mississippi Medical Center (UMMC)). As shown, a user may be enabled to provide user input (e.g., user input 302), where the user input is a direct query to the MIPA model 210. As described herein, user input (e.g., user input 302) may be in the form of text-based input (e.g., a user may leverage the user interface 301 to type a question, comment, and/or query) and/or audio-based input (e.g., the user may provide conversational, speech-based input). For example, as shown in FIG. 3, the user input 302 may be conversational input provided by the user which the MIPA model 210 has processed and leveraged various speech-to-text techniques in order to render the user's conversational input on the user interface 301. In various other examples, the user input 302 may be text-based input generated by the user via the user interface 301 (e.g., user input typed by the user using an interactive user interface element such as a digital keyboard).

As described herein, the MIPA model 210 may be configured to employ one or more OCR and/or NLP techniques to extract various data features from scanned physical correspondence and/or digital correspondence (e.g., email, SMS messages) to determine a series of actionable and user-specific topics, pathways, goals (e.g., primary goal, subgoals), insights, opportunities, action item lists, tradeoffs, and/or the like for the user based on the subject matter of the correspondence. Non-limiting examples of the types of data features extracted from the digital correspondence 304 may be a location of the medical residency program to which the user has been accepted, a salary associated with the residency program, one or more persons of interest (e.g., program directors, mentors, managers, administrative personnel), a timeframe associated with the residency program, various personnel contact information, and/or the like.

Once one or more pieces of scanned physical correspondence and/or digital correspondence (e.g., digital correspondence 304) have been processed by the MIPA model 210, the MIPA model 210 may be configured to provide one or more representations of any user-specific topics, pathways, goals (e.g., primary goal, subgoals), insights, opportunities, action item lists, tradeoffs, and/or the like generated for the user based on the scanned physical correspondence and/or digital correspondence. For example, as shown on the user interface 303, the MIPA model 210 has generated and caused the display of model output 306 configured as conversational text that indicates that the MIPA model 210 has processed (e.g., interpreted, parsed, analyzed, and/or the like) the digital correspondence 304 by providing details associated with the digital correspondence back to the user. For example, the model output 306 indicates key information related to the digital correspondence 304 (e.g., the user's acceptance to the residency program and the corresponding start date).

Additionally, the MIPA system 102 may leverage the MIPA management circuitry 208 to generate and display various interactive user interface elements (e.g., interactive user interface elements 308A-308N) related to one or more user-specific topics, goals (e.g., primary goal, subgoals), insights, opportunities, action item lists, tradeoffs, and/or the like generated by the MIPA model 210. For example, interactive user interface element 308A indicates that the MIPA model 210 has automatically generated a new topic for the user titled “Moving to Mississippi.” The interactive user interface element 308B indicates that the MIPA model 210 has generated an insight related to an expected (e.g., increased) buying power achieved by the user based on the average cost-of-living expenses associated with the location of the residency program to which the user has been accepted (Jackson, Mississippi).

The interactive user interface element 308C indicates that the MIPA model 210 has identified one or more places to live (e.g., apartments, condominiums, single-family homes) in a living location proximate to the location of the residency program to which the user has been accepted (in one or more neighborhoods near UMMC and/or greater Jackson, Mississippi). The interactive user interface element 308C indicates that the MIPA model 210 has generated one or more insights related to the taxes (e.g., sales taxes, income taxes, property taxes, and/or the like) associated with the location of the residency program to which the user has been accepted (Jackson, Mississippi). In this regard, one or more interactive user interface elements (e.g., interactive user interface elements 308A-308N) may be configured to enable a user to access one or more software application modules (e.g., a cost-of-living impact tool, a financial status X-ray tool) and/or one or more portions of descriptive and/or interactive data associated with model output generated by the MIPA model 210.

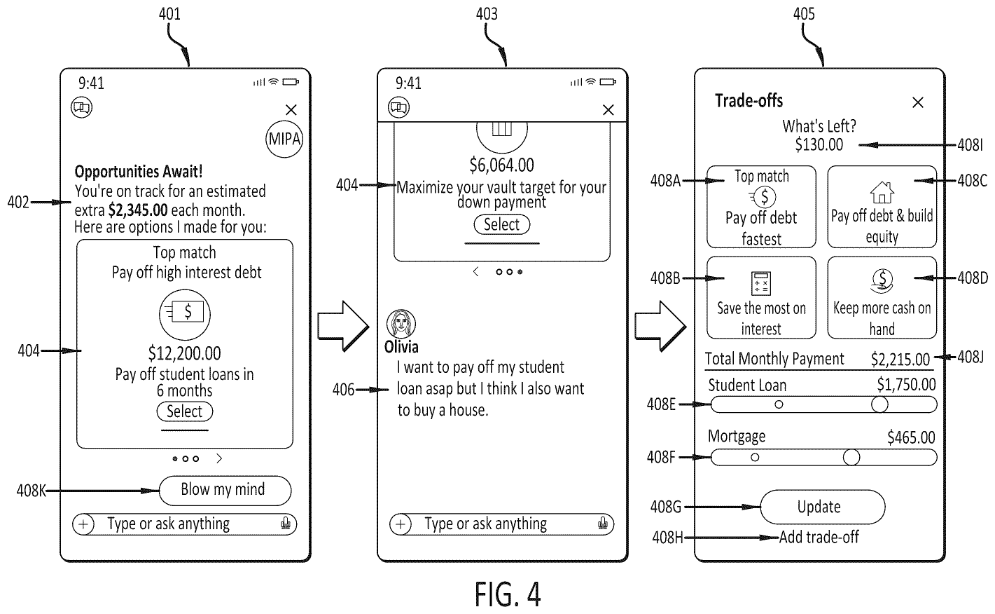

FIG. 4 illustrates additional example user interfaces of an example software application instance integrated with the MIPA model 210 configured to provide MIPA in accordance with some examples described herein. Specifically, FIG. 4 illustrates a use case in which the MIPA model 210 may be configured to present a user with various pathways, goals (primary goals, subgoals), opportunities, action items, and/or tradeoffs based on the determination that a user may have (currently or in the near future) access to additional funds (e.g., funds not historically received by the user). In continuing the example illustrated in FIG. 3, the MIPA model 210 may determine a user has (or will have) an increase in regular income (e.g., an increase in salary) based on the user's acceptance to a medical residency program.

For example, as shown on user interface 401, the MIPA model 210 (e.g., in conjunction with the MIPA management circuitry 208) may cause the display of model output 402 that indicates an amount of money (e.g., $2,345.00) that the user may have access to based on the acceptance of a new role (e.g., a medical residency position). Based on the increase in the amount of money the user is set to receive due to the salary associated with the new role, the MIPA model 210 may generate, identify, and/or otherwise determine one or more pathways, goals (primary goals, subgoals), action items, and/or opportunities for the user. In some examples, the MIPA model 210 (e.g., in conjunction with the MIPA management circuitry 208) may cause the display of an opportunity reel (e.g., opportunity reel 404) indicating one or more pathways, goals (primary goals, subgoals), action items, and/or opportunities the user may be interested in pursuing. In some examples, the opportunity reel may be configured as an interactive carousel, where the carousel comprises one or more interactive cards associated with one or more pathways, goals (primary goals, subgoals), action items, opportunities, and/or the like that may be viewed, accessed, and/or otherwise manipulated by the user.

For example, on the user interface 401, the opportunity reel 404 is displaying a first pathway for the user that is related to paying off the user's high interest debt. In this example, the opportunity reel 404 is configured to indicate that the user's current high interest debt (e.g., student loan debt) is in the amount of $12,200.00 and that the MIPA model 210 has determined a set of steps (e.g., a set of action items) the user may execute (in whole or in conjunction with the MIPA model 210) to eliminate the high interest debt in six months. As another example and as shown on user interface 403, the opportunity reel 404 is configured to display a second pathway for the user that is related to contributing to a “vault” (e.g., a savings account, savings category, budget fund) associated with a future down payment on a new residence (e.g., a house, apartment, or the like).

Also illustrated on the user interface 403 is the user input 406 generated by the user in response to viewing one or more of the pathways, goals (primary goals, subgoals), action items, and/or opportunities presented by the MIPA model 210 in the opportunity reel 404. As shown, user input (e.g., user input 406) may be associated with a user's desire to plan for and/or execute a particular goal and/or explore particular pathways, goals (primary goals, subgoals), action items, and/or opportunities. For example, the user input 406 indicates the user's desire to both pay off high interest student loans, but also indicates the user's interest in buying a house. Based on user input (e.g., user input 406), the MIPA model 210 may be configured to cause the presentation of various pathways, goals (primary goals, subgoals), action items, and/or opportunities, and/or describe the various tradeoffs associated with executing the one or more pathways, goals (primary goals, subgoals), action items, and/or opportunities.

As shown in FIG. 4, the MIPA model 210 (e.g., in conjunction with the MIPA management circuitry 208) may be configured generate and/or cause the display of an additional user interface (e.g., user interface 405) in response to receiving the user's input (e.g., user input 406). The user interface (e.g., user interface 405) may be configured to enable a user to explore various tradeoffs that may occur as a result of executing one or more pathways, goals (primary goals, subgoals), action items, and/or opportunities. For example, a user interface (e.g., user interface 405) may be configured to display a plurality of interactive user interface elements (e.g., interactive user interface elements 408A-408J) configured to visualize the tradeoffs involved in undertaking various pathways, goals, and/or actions with the additional funds from the salary garnered by the user as a result of taking a new job.

For example, an interactive user interface element (interactive user interface element 408A) may be associated with a pathway related to paying off the high interest debt of a user. As another example, an interactive user interface element (interactive user interface element 408B) may be associated with a pathway related to paying off various debt while also building home equity. As yet another example, an interactive user interface element (interactive user interface element 408C) may be associated with a pathway related to leveraging one or more action items that may lead to an optimization of the user's finances to reduce interest payments on various possessions, debts, and/or the like. As another example, an interactive user interface element (interactive user interface element 408D) may be associated with a pathway configured to enable the user to keep a relatively higher amount of cash on hand (e.g., relative to the user's historical amount of liquid funds).

In some examples, a plurality of interactive user interface elements (e.g., interactive user interface elements 408A-408J) configured to visualize one or more tradeoffs may be associated with pre-solved model output generated by the MIPA model 210. For example, as shown on the user interface 405, the interactive user interface element 408A associated with a pathway related to paying of the user's high interest dept has been selected. As a result of the selection, interactive user interface elements 408E and 408F configured as sliders associated with an amount of money that may be used to pay off high interest debt (e.g., student loan debt) and pay towards a mortgage respectively are pre-configured according to suggested values generated by the MIPA model 210. The suggested values indicated by the preconfigured interactive user interface elements 408E and 408F may represent monetary values associated with a portion of any additional funds received from the user's new role (e.g., $2,345 monthly). The suggested values may be generated by the MIPA model 210 and may indicate the most optimal values for paying off the user's high interest debt (e.g., student loan debt) in the shortest amount of time. The user interface (e.g., user interface 40) may also comprise interactive user interface elements (e.g., interactive user interface elements 408J and 408I) configured to indicate a total amount of allocated funds (e.g., funds allocated to paying off the high interest debt and mortgage) suggested by the MIPA model 210 as well as a remaining amount of funds after the suggested amount of allocated funds has been applied accordingly.

Furthermore, the plurality of interactive user interface elements (e.g., interactive user interface elements 408A-408J) may enable a user to interact with the pre-solved model output generated by the MIPA model 210 and to adjust various parameters (e.g., monetary values, account parameters, monthly fund allocations, and/or the like) associated with the various opportunities, action items, insights, and/or the like generated by the MIPA model 210. For example, the user may be enabled to adjust one or more value associated with any suggested allocation of funds via one or more interactive user interface elements (e.g., interactive user interface elements 408E and/or 408F). For instance, the user may desire to put less money towards their high interest debt (e.g., student loan debt) and more money towards a mortgage payment. In this regard, the MIPA system 102 provides the benefit of enabling a user to augment one or more respective pathways, goals (primary goals, subgoals), action items, and/or opportunities generated by the MIPA model 210 in order to best suit the preferences of the user.

Additionally, in various examples, the MIPA model 210 may be configured to rank one or more pathways, goals (primary goals, subgoals), action items, and/or opportunities that the MIPA model 210 has generated for the user. As such, the MIPA model 210 may be configured to indicate to the user the best path forward (e.g., the highest ranked pathway) by, for example, configuring a respective interactive user interface element (e.g., interactive user interface element 408A) associated with a respective pathway, goal, action item, and/or opportunity to display a respective badge, icon, tag, flag, and/or the like. For example, as shown, the interactive user interface element 408A associated with a pathway related to paying off the user's high interest debt has been configured to display a “top match” tag.

The MIPA model 210 may be configured to rank one or more pathways, goals (primary goals, subgoals), action items, and/or opportunities based on a predicted impact each respective pathway, goal (e.g., primary goal, subgoal), action item, and/or opportunity may have on the financial status of a respective user. For instance, a pathway that is predicted to have the greatest positive impact on the financial status may be ranked the highest among a set of pathways, goals (primary goals, subgoals), action items, and/or opportunities.

The MIPA model 210 may determine a predicted impact of a respective pathway, goal (e.g., primary goal, subgoal), action item, and/or opportunity based on an inferred change to the user's current and/or future (e.g., inferred, predicted) financial status that may occur as a result of executing the pathway, goal (e.g., primary goal, subgoal), action item, and/or opportunity. Positive impacts may be associated with debt reduction, financial account interest accrual (e.g., savings interest), accrual of fund savings, potential progress made towards the achievement of particular goals (e.g., paying off a mortgage), predicted investment returns (e.g., stock market investment returns, investment property returns), and/or the like. The predicted impact of a particular pathway, goal (e.g., primary goal, subgoal), action item, and/or opportunity may be determined on a user-specific basis.

As an example, for two distinct users who may be receiving additional funds than is historically typical for the two users (e.g., due to taking on a new role, getting a promotion, and/or the like) a first pathway configured to reduce high interest debt may be relatively more impactful to the current or future (e.g., inferred, predicted) financial status of a first user than a second user if the first user has more debt and/or debt with a high interest rate relative to the second user. Similarly, a second pathway configured to assist the second user in saving additional funds may be relatively more impactful to the current or future (e.g., inferred, predicted) financial status of the second user than the first user as the second user may have one or more instantiated goals related to making a large purchase (e.g., a home purchase).

Based on one or more user interactions (e.g., user inputs, selection indications) with the various interactive user interface elements (e.g., interactive user interface element 408G configured as a button) on a respective user interface (e.g., user interface 405), the MIPA model 210 may be configured to instantiate and/or update one or more pathways, goals (e.g., primary goal, subgoals), and/or like for a respective user. Furthermore, such instantiation and/or updating may cause the MIPA model 210 to update one or more established topics associated with the respective user. Additionally, based on one or more user interactions (e.g., user inputs, selection indications) with the various interactive user interface elements (e.g., interactive user interface element 408H configured as a hyperlink) on a respective user interface (e.g., user interface 405), the MIPA model 210 may be directed to generate one or more additional tradeoffs relative to the one or more tradeoffs currently displayed on the respective user interface. In this regard, the MIPA system 102 may enable a user to further explore how executing one or more pathways, goals (primary goals, subgoals), action items, and/or opportunities may affect any current (established) pathways, goals (primary goals, subgoals), action items, and/or opportunities previously initiated by the user.

In some examples, the MIPA model 210 may be configured to generate various pathways, goals (primary goals, subgoals), action items, and/or opportunities that may be potentially counterintuitive, out-of-character, and/or potentially inconsistent with a particular user's behavior or lifestyle. For example, as described herein, the MIPA model 210 may be configured determine one or more character traits and/or attributes of a particular user, as well as one or more personal relationships associated with the particular user. For example, the MIPA model 210 may determine that a particular user is not in a relationship, has no current dependents, has no current roommates, and that the user is interested in building equity in a new house. In such an example, the MIPA model 210 may be configured to, based on a user interaction (e.g., user inputs, selection indications) with a respective interactive user interface element (e.g., interactive user interface element 408K configured as a button) on a respective user interface (e.g., user interface 401), generate one or more out-of-character pathways, goals (primary goals, subgoals), action items, and/or opportunities for the user in order to accelerate the progress of the user's goal to build equity. As an example, the MIPA model 210 may generate an out-of-character action item for the user that is related to listing one or more bedrooms of the user's house (or the user's future house) for rent in order to generate an additional source of income to be applied to the mortgage associated with the user's house.

FIG. 5 illustrates additional example user interfaces of an example software application instance integrated with the MIPA model 210 configured to provide MIPA in accordance with some examples described herein. Specifically, FIG. 5 illustrates a use case in which the MIPA model 210 may be configured to integrate with a cost-of-living impact tool. In continuing the example referenced in the sections corresponding to FIGS. 3-4, the MIPA model 210 may determine a user has (or will have) an increase in the user's regular income (e.g., an increase in salary) based on the user's acceptance to a new role (e.g., into a medical residency program). Furthermore, the MIPA model 210 may determine that the user will need to relocate from a first (e.g., current) living location to a second living location proximate to the user's new place of employment.

The MIPA model 210 may integrate with the cost-of-living impact tool in order to retrieve, process, and/or provide data related to various benefits and/or disadvantages of living in a first living location (e.g., a geolocation, city, neighborhood, county, and/or the like where the user currently lives) relative to living in a second living location (e.g., a geolocation, city, neighborhood, county, and/or the like to which the user may relocate). In some examples, the MIPA model 210 may provide data related to such benefits and/or disadvantages associated with the first and second living locations based on the current and/or future (e.g., inferred, predicted) financial status of the user. Such a cost-of-living impact tool may be beneficial to a user taking a new job in a new living location and may help the user account for issues related to the move that they may have not previously considered. For example, the MIPA model 210 may generate a buying power visualization (e.g., buying power visualization 504), execute a neighborhood analysis for the second living location (e.g., the destination living location), and/or generate various opportunities for the user based on any increased monthly income generated based on moving to the second living location to take the new job.

As shown in FIG. 5, a user interface (e.g., user interface 501) may be configured to display a buying power visualization (e.g., buying power visualization 504) that describes various insights generated by the MIPA model 210. The buying power visualization (e.g., buying power visualization 504) may be an interactive comparison module configured to compare various cost-of-living data of the first living location to the second living location based on data associated with the respective location identification codes (e.g., zip codes, postal codes, pin codes) associated with the first and second living locations. As shown by the user interface 501, the buying powering visualization 504 may indicate a total change in buying power based on the change in the cost-of-living (e.g., a percentage of increase or decrease in the cost-of-living) the user will experience if they move. For example, the buying power visualization may compare and display various data related to the first living location (e.g., New York, NY) and the second living location (e.g., Jackson, MS) such as the average annual income of the residents in a respective living location, average local tax expenditures, projected monthly expenses (e.g., utilities, mortgage, food cost), and/or the like.

Additionally, the MIPA model 210 may factor in any additional monthly income the user may acquire by accepting a particular job in the second living location (e.g., the destination living location) when determining the buying power and/or generating various pathways, goals (e.g., primary goals, subgoals), action items, opportunities, and/or the like for the user. For example, the MIPA model 210 may generate model output (e.g., model output 502A) associated with various insights related to an increased buying power (e.g., a 61% relative increase in buying power) the user may experience based on an expected salary (e.g., $55,000 annually) the user will make in the second living location.

The cost-of-living impact tool may also comprise a neighborhood analysis module. The neighborhood analysis module may be an interactive module managed by the MIPA management circuitry 208 and may comprise interactive maps configured to visualize various neighborhoods and/or districts (e.g., associated with respective zip codes) related to the second living location (e.g., the destination living location). In this regard, the MIPA model 210 may be configured to analyze various neighborhoods, boroughs, and/or districts based on living location data retrieved by the external data circuitry 214. The living location data may comprise various living location attributes including one or more of transit score data, safety data (e.g., crime rate data), walkability data (e.g., data related to how walkable a location is), work commute distance (e.g., based on location of new job), population density data, resident income data, property cost data (e.g., average rental costs, home ownership costs, property taxes, utility costs), and/or the like.

A respective living location attribute may be associated with a respective score or percentage (e.g., a numerical value, numerical grade, numerical range) that indicates a qualitative metric associated with the respective living location attribute. In some examples, a score or percentage associated with a respective living location attribute may be a relative score or relative percentage generated based on one or more national and/or local averages, such that a higher relative score or relative percentage may indicate that a first living location is more desirable than one or more other living locations. In this regard, one or more interactive user interface elements (e.g., interactive user interface elements 506E and 506F) may be configured to visually represent one or more portions of living location data and/or corresponding living location attributes associated with a respective living location (e.g., a second living location to which a user may relocate).

Based on a user's current and/or predicted financial status, the MIPA model 210 may rank and/or recommend a set of neighborhoods, boroughs, and/or districts for the user to consider before relocating. In some examples, the MIPA model 210 may rank and/or recommend a set of neighborhoods for the user based on one or more similar users associated with the user's peer group that live in a second living location to which the user may relocate. Additionally or alternatively, the MIPA model 210 may be configured rank and/or recommend a set of neighborhoods, boroughs, and/or districts for a respective user based on user data related to one or more personal relationships of the user. For example, if the user has one or more school-aged dependents, the MIPA model 210 may assign a higher relative rank to one or more neighborhoods, boroughs, and/or districts associated with school districts that have high education system ranking scores that meet and/or exceed a predetermined education system ranking score threshold.

In some examples, the predetermined education system ranking score threshold may be predetermined by the MIPA model 210. In other examples, the predetermined education system ranking score threshold may be set by a respective user. For example, the user may indicate to the MIPA model 210 that the user wishes to move to a living location associated with a school district and/or education system with a particular education system ranking score (e.g., above a certain value or within a certain range, such as a score of 8+ out of 10 and/or the like). In various examples, an education system ranking score may be generated based on various nationally recognized education system ranking standards (e.g., standardized testing scores, teacher ratings, school ratings and/or the like).

In this regard, the neighborhood analysis module may be configured to display data related to the top ranked neighborhoods, boroughs, and/or districts the MIPA model 210 has identified for the user. For example, the MIPA model 210 may generate model output (e.g., model output 502B) configured to indicate a top ranked neighborhood in the second living location, where the top ranked neighborhood has been determined (e.g., classified) by the MIPA model 210 based on one or more of living location data associated with the second living location (e.g., education system ranking score data) and/or user data, peer group data, personal relationship data, financial status data, career data, and/or the like associated with the user.

Additionally, the MIPA model 210 may be configured to demonstrate “explainable AI” methodologies such that the MIPA model 210 may indicate to the user why certain recommendations (e.g., recommendations for a top ranked neighborhood) have been generated for the user. For example, based on an interaction with an interactive user interface element (e.g., interactive user interface elements 506D), the MIPA model 210 may be configured to generate and provide model output that describes the specific data and/or considerations utilized by the MIPA model 210 to rank certain neighborhoods, boroughs, and/or districts associated with a particular living location. In some example, such model output associated with the explainable AI aspects related to the ranking and/or recommendation of a particular neighborhood, borough, and/or district may be text-based output displayed on a user interface (e.g., user interface 505) and/or a text document automatically generated and delivered by the MIPA model 210 to a user's email account. Additionally or alternatively, such model output associated with the explainable AI aspects related to the ranking and/or recommendation of a particular neighborhood, borough, and/or district may be audio output (e.g., synthetic speech output) generated by the MIPA model 210 that is configured to explain why a particular neighborhood, borough, and/or district may be ranked as a top choice for a respective user.

As shown on user interfaces 503 and 505, the cost-of-living impact tool may be associated with various interactive user interface elements (e.g., interactive user interface elements 506A-506N) configured to enable a user to explore one or more living locations (e.g., a second living location to which a respective user may relocate). For instance, a user may be enabled to select a respective neighborhood, borough, or district by manually entering a location identification code such as a zip code (e.g., via the interactive user interface element 506A) or selecting the respective neighborhood, borough, or district on an interactive map (e.g., interactive user interface element 506E).

Furthermore, the MIPA model 210 may also leverage the cost-of-living impact tool to obtain and/or update various user data by prompting the user to confirm their current income data (e.g., update previously instantiated income data based on new job) and/or household data (e.g., whether the user will part of a single or joint household), which may impact the neighborhood analysis and/or recommendations generated with respect to one or more potential neighborhoods. For example, as shown on the user interface 503, an interactive user interface element (e.g., interactive user interface element 506B) may be associated with a prompt soliciting user input related to the current income (e.g., salary income) associated with a respective user. Additionally, one or more interactive user interface elements (e.g., interactive user interface element 506C) may be configured to solicit user input related to a tax filing status associated with the user's household (e.g., whether the user will be filing taxes as a “single” individually, or “jointly” with a spouse associated with the user). In various examples, such information collected via a respective user interface associated with the cost-of-living impact tool may be utilized by the MIPA model 210 to update an existing profile and/or various existing user data (e.g., data related to an established topic) associated with a respective user. As such, any user data provided by a user via the cost-of-living impact tool may be utilized by the MIPA model 210 in various other MIPA operations such as the generation and/or instantiation of various pathways, goals (primary goals, subgoals), action items, and/or opportunities.

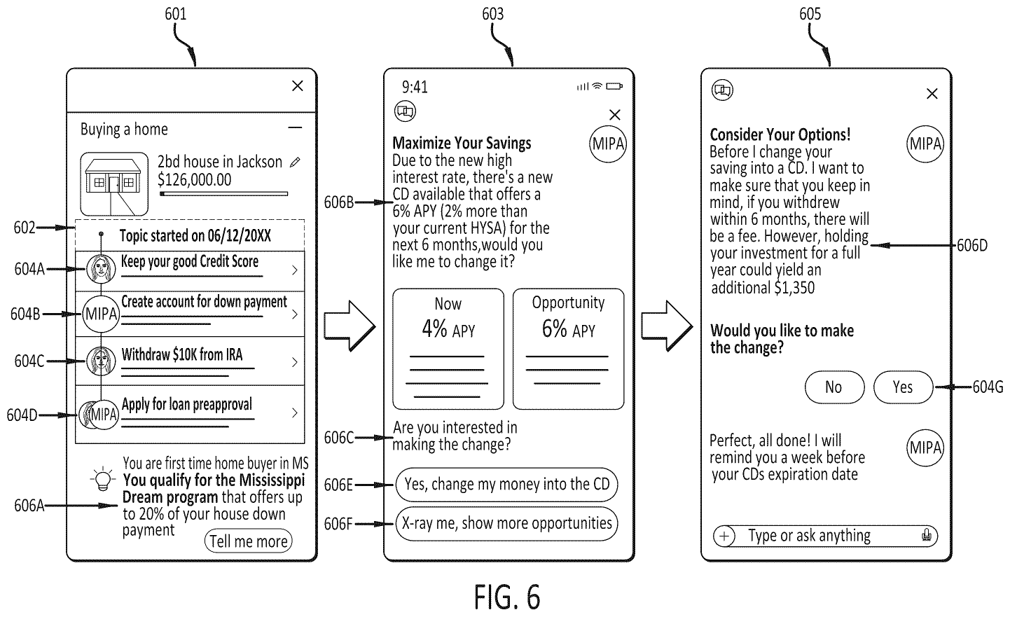

FIG. 6 illustrates additional example user interfaces of an example software application instance integrated with the MIPA model 210 configured to provide MIPA in accordance with some examples described herein. Specifically, FIG. 6 illustrates a use case in which the MIPA model 210 may be configured to generate an action item list for a user based on one or more interactions with the user. In some examples, an action item list may be associated with a particular topic and/or pathway and may be associated with one or more goals (e.g., primary goals, subgoals) linked to the particular topic and/or pathway. In some examples, the action item list may be a to-do list comprising a set of action items associated with a set of subgoals designed to achieve the satisfactory completion of a primary goal upon the cumulative execution of the set of action items.

For example, as shown in FIG. 6, the user interface 601 has been configured to display an action item list 602 related to a topic titled “Buying a Home” generated by the MIPA model 210 based on one or more interactions with the user (e.g., conversations, documentation uploads, and/or the like). In continuing the example referenced in the descriptions related to FIGS. 3-5, a user may upload documentation (e.g., digital correspondence 304) and provide various user input (e.g., user input 302, user input 406) related to a new role that the user is taking in another state (e.g., a role in a medical residency program at UMMC). In such an example, the MIPA model 210 may generate a topic such as Buying a Home associated with various pathways designed to assist the user in achieving various goals related to purchasing a new home in a new living location.

In some examples, the MIPA model 210 may be configured to identify one or more real estate listings in a respective neighborhood, borough, and/or district associated with a living location in which the user may relocate. For example, the user may be enabled to leverage the MIPA model 210 via a cost-of-living impact tool comprising a neighborhood analysis module to identify one or more real estate listings associated with a respective neighborhood that the MIPA model 210 has recommended for the user (e.g., a top ranked neighborhood). Additionally or alternatively, in some examples, a user may be enabled to upload various data associated with one or more real estate listings that the user has identified. For example, the MIPA model 210 may be configured to retrieve various data associated with a respective real estate listing based on one or more identifiers provided by the user (e.g., multiple listing service (MLS) numbers, address information, property identifiers, parcel identification numbers, real estate listing hyperlinks, and/or the like).

In some examples, once the user has identified a real estate listing of interest, the MIPA model 210 may be configured to generate an action item list (e.g., action item list 602) configured to facilitate the purchase of the identified real estate listing of interest. The MIPA model 210 (e.g., in conjunction with the MIPA management circuitry 208) may be configured to display the action item list (e.g., action item list 602) via a respective user interface (e.g., user interface 601). One or more action items comprised in the action item list (e.g., action item list 602) may be associated with one or more respective interactive user interface elements (e.g., interactive user interface elements 604A-604D).

Additionally, as described herein, the MIPA model 210 may be configured to determine whose responsibility it is to complete a particular action item in a respective action item list that is associated with a respective goal (e.g., primary goal, subgoal) related to a particular topic and/or pathway. For example, the MIPA model 210 may determine that a respective user is solely responsible for, or indeed the only entity capable, of completing one or more tasks associated with a respective action item. Alternatively, in other examples, the MIPA model 210 may be configured to execute various action items on behalf of the user and therefore may assign the responsibility for executing such action items to the MIPA model 210 itself.

Additionally or alternatively, the MIPA model 210 may assign joint responsibility to both the respective user and the MIPA model 210 itself for executing a particular action item associated with an action item list (e.g., a to-do list) related to a respective topic and/or pathway.

For example, the MIPA model 210 may generate a first action item (e.g., associated with interactive user interface element 604A) may be associated with one or more insights and/or instructions related to maintaining the user's current credit score. As the user is the only entity capable of maintaining the user's current credit score, the MIPA model 210 may assign sole responsibility for executing the first action item to the user. As another example, a second action item (e.g., associated with interactive user interface element 604C) may be associated with withdrawing a predetermined amount of money (e.g., $10,000) from an IRA investment account associated with the user.

In such an example, the MIPA model 210 may determine that the user is a first-time home buyer and, as such, qualifies for an exemption program in which first-time home buyers can withdraw funds (e.g., by liquidating stock or mutual fund positions) from an IRA investment account without incurring a penalty (e.g., a state and/or federally mandated tax penalty). In such an example, the MIPA model 210 may not yet have the required access permissions to make investment trades on behalf of the user and may therefore determine that the user is the only entity capable of withdrawing the predetermined amount of money from the IRA investment account. Alternatively, in some examples the MIPA model 210 may be configured to execute and/or automate various investment-related action items on behalf of a respective user and may automatically determine which investment products (e.g., stocks, mutual funds, electronically traded funds (ETFs), and/or the like) associated with an investment account associated with the user (e.g., an IRA investment account, brokerage account, and/or the like) should be liquidated in order to execute the investment-related action items.

As another example, the MIPA model 210 may generate a third action item (e.g., associated with interactive user interface element 604B) may be associated with creating a financial account and setting up automatic fund transfers for a down deposit on the identified real estate listing of interest. In such an example, the MIPA model 210 may be configured to automatically create an account (e.g., a user account, financial account, enterprise account, and/or the like) for the user. As such, the MIPA model 210 may assign responsibility for executing the third action item to the MIPA model 210 itself. In such examples, the MIPA model 210 may be configured to solicit authorization (e.g., verbal authorization, electronic signature) from the user prior to executing the third action item on the user's behalf.

As yet another example, the MIPA model 210 may assign joint responsibility to both a respective user and the MIPA model 210 itself for executing a particular action item associated with an action item list (e.g., action item list 602) related to a respective topic and/or pathway. In this regard, various tasks associated with an action item may be completed by the user and the MIPA model 210 in tandem. For example, the MIPA model 210 may generate a fourth action item (e.g., associated with interactive user interface element 604D) for a user that involves applying for a loan preapproval for a potential purchase of the identified real estate listing of interest. In such an example, the user may need to meet with an enterprise representative (e.g., a premier banker, loan officer, and/or the like). While the MIPA model 210 may be configured to initiate the scheduling of an appointment with the enterprise representative, the user may be required to confirm the date and time of the appointment and subsequently participate in a meeting with the enterprise representative. As such, in this example, the MIPA model 210 may be configured to assign joint responsibility to both the user and the MIPA model 210 itself for executing the fourth action item associated with applying for the loan preapproval.

Furthermore, each of the one or more interactive user interface elements (e.g., interactive user interface elements 604A-604D) associated with the respective action items of an action item list (e.g., action item list 602) may be configured to display an indication of the entity responsible for executing a respective action item. For example, a respective interactive user interface element (e.g., interactive user interface element 604A) may be configured to display an image, graphic, icon, and/or any other appropriate visual identifier associated with a respective user and/or the MIPA model 210 depending on which entity is responsible for executing a respective action item.

In addition to providing an action item list (e.g., action item list 602) based on a respective topic, the MIPA model 210 may be configured to determine various contextual opportunities that may supplement the user's progress toward completing a primary goal (e.g., purchasing a real estate listing of interest) and/or one or more subgoals (e.g., subgoals associated with respective action items associated with the action item list. For example, the MIPA model 210 may determine one or more contextual opportunities for a user working on saving funds to apply towards a major purchase (e.g., a down deposit towards a real east listing of interest). As shown on the user interface 601, the MIPA model 210 may determine one or more first-time home buyer programs that the user may be able to leverage. For example, as indicated in the model output 606A generated by the MIPA model 210, the user may qualify for a first-time home buyer program (e.g., the “Mississippi Dream Program”) that gives first-time home buyers access to funds to apply towards a down payment on a respective piece of real estate (e.g., 20% of the projected down payment).

As another example and as shown on the user interface 603, the MIPA model 210 may determine contextual opportunities for a user related to one or more products (e.g., financial products) associated with a respective enterprise. In such examples, the enterprise associated with the one or more products may be the enterprise employing the MIPA system 102. In various other examples, the MIPA model 210 may identify one or more products associated with one or more third-party enterprises (e.g., third-party institutions, organizations, businesses, and/or the like). For example, the model output (e.g., model output 606B) generated by the MIPA model 210 may describe a product (e.g., a financial product) that may accelerate the user's progress towards achieving a particular goal (e.g., a savings goal related to the down payment on a real estate listing of interest).

For instance, the model output 606B describes a certificate of deposit (CD) offering a higher annual percentage yield (APY) relative to a savings account (e.g., a high yield savings account such as a money market account) that the user is currently using to store monetary funds. In the example displayed on user interface 603, the CD may be associated with a six-month timeline. In this regard, the MIPA model 210 may be configured to determine whether an opportunity (e.g., an available product such as the CD) that is associated with various restrictions (e.g., time restrictions, fund limit restrictions) aligns with a predetermined timeframe (e.g., schedule, timeline) associated with an established pathway. In the example illustrated in FIG. 6, the MIPA model 210 may determine that the user will not necessarily need access to a predetermined amount of funds for a predetermined period of time (e.g., six or more months) as the user may not need to purchase a home and relocate to a new living location until a certain time of year (e.g., a month prior to the start date of a new job role), giving the user flexibility to take advantage of the CD.

In such an example, the MIPA model 210 may display a prompt to the user (e.g., model out 606C, model output 606D) to determine if the user wishes to transfer funds from an existing financial account (e.g., the high yield savings account) to the CD that the MIPA model 210 has identified. In some examples, and as described herein, a user may be enabled to interact with one or more interactive user interface elements (e.g., interactive user interface elements 604E and/or 604G respectively) in order to provide affirmative user input in response to a prompt provided by the MIPA model 210. For example, the user may provide a selection indication with respect to an interactive user interface element (e.g., interactive user interface element 604E) in order to cause the MIPA model 210 to initiate the transfer of funds from the existing financial account to the CD. Alternatively, in some examples, the user may provide a selection indication with respect to an interactive user interface element (e.g., interactive user interface element 604F) in order to cause the MIPA system 102 to display additional opportunities, action items, and/or pathways that the user may wish to execute in addition to, or lieu of, the one or more action items associated with the currently display action item list (e.g., action item list 602) and/or the opportunity currently being presented to the user.

As shown on user interface 605, the MIPA model 210 may provide specific data related to the results of executing taking advantage of a specific opportunity. For example, the model output 606D describes an amount of interest the user may accrue by transferring the funds from their existing savings account to the CD identified by the MIPA model 210. The MIPA model 210 may also provide the user with information related to one or more restrictions, consequences, fees, and/or adverse impacts the user may experience if the user does not follow one or more guidelines associated with an opportunity (e.g., a fee associated with withdrawing money from the CD before a maturity date has been reached).

FIG. 7 illustrates additional example user interfaces of an example software application instance integrated with the MIPA model 210 configured to provide MIPA in accordance with some examples described herein. Specifically, FIG. 7 illustrates a use case in which the software application instance associated with the MIPA system 102 may be configured to enable a user to access various data generated by the MIPA model 210. For example, the user interface 701 has been configured to display a plurality of interactive user interface elements (e.g., interactive user interface elements 702A-702C) associated with various respective topics generated by the MIPA model 210 based on one or more interactions with a respective user. Additionally, the user interface 701 has been configured to display an interactive user interface element (e.g., interactive user interface element 702D) associated with one or more action item lists (e.g., to-do lists) generated by the MIPA model 210 based on various interactions with a respective user. Additionally, the user interface 701 has been configured to display an interactive user interface element (e.g., interactive user interface element 702E) associated with a financial status X-ray tool configured to integrate with the MIPA model 210.

The user interface 703 shows an example configuration associated with the financial status X-ray tool. As described herein, the financial status X-ray tool may be a software-based module integrated with the software application instance associated with the MIPA system 102. The financial status X-ray tool may be configured to aggregate, compile, and/or analyze various financial data associated with the user (e.g., data related to banks accounts, transaction history, deposit history, investment portfolio performance, investment dividends, beneficiary data, credit data, mortgage data) from various internal and external sources to determine the user's current financial status. As such, the MIPA model 210 may be configured to leverage the financial status X-ray tool to generate a financial flow visualization (e.g., financial flow visualization 706) comprising various graphs, charts, images, and/or animations related to the intake and/or expenditure of the user's money. Additionally, the MIPA model 210 may categorize and/or classify certain funds in order to inform the user where their money is coming from (e.g., salary, dividends, real estate investment properties, and/or the like) and/or being allocated to (e.g., expenses, debt (e.g., credit debt, mortgage debt), investments, established pathways, and/or the like).

Additionally, the MIPA model 210 may leverage the financial status X-ray tool configured to leverage various known data related to a user's assets in order to generate and display various insights via the financial flow visualization (e.g., financial flow visualization 706). For instance, the MIPA model 210 may be configured to retrieve amortization data associated with one or more financed purchases and/or financial loans associated with the user and generate various summary data to present to the user. For example, the financial flow visualization (e.g., financial flow visualization 706) may be configured to graphically display the various summary data generated by the MIPA model 210 associated with a mortgage payoff timeline associated with the user's primary residence. Such summary data may be generated by the MIPA model 210 based on financial history data associated with one or more financial accounts of the user. For example, the MIPA model 210 may be configured to determine that a user routinely makes additional payments towards the principal value associated with the mortgage on the user's primary residence.

As another example, the financial flow visualization (e.g., financial flow visualization 706) may be configured to graphically display various summary data generated by the MIPA model 210 associated with an estimated credit card pay-off timeline. In this regard, the MIPA model 210 may be configured to retrieve credit card balance data (e.g., transaction history data, payment data) associated with a respective credit account to determine how long the user may maintain a current balance on a respective credit card. Additionally or alternatively, the financial flow visualization (e.g., financial flow visualization 706) may be configured to graphically display various summary data generated by the MIPA model 210 associated with an annual financial status report.

In such examples, the financial status report may detail various metrics associated with a most recent calendar year including various spending, saving, investments, gross income, net income, investment income, retirement account income, expenditures, and/or the like. In some examples, the financial status report may detail a percentage of growth of the assets of the user year-over-year. Additionally or alternatively, the financial status report may be associated with an available amount of funds the user may be able to spend in retirement per year. For example, the MIPA model 210 may determine that the user is able to spend $110,000 per year in retirement and how the potential retirement spending corresponds to the current salary of the user (e.g., 42% of the user's current salary).

In some examples, the financial status X-ray tool may be configured to identify changes to a user's financial status that may necessitate, and/or benefit from, executing various actions. For instance, based on changes in the user's current financial status, the MIPA model 210 may evaluate and/or present various opportunities, scenarios, trade-offs, and/or “what-ifs” to the user, as well as any currently active primary goals and/or subgoals, via the financial status X-ray tool. For instance, the financial status X-ray tool may comprise an opportunity reel (e.g., opportunity reel 704) which may be configured as a carousel configured to display a continuously updated list of potential opportunities for the user based on the user's current financial status. Such opportunities may be displayed as interactive user interface elements configured to describe action items a user may wish to execute. For example, the MIPA model 210 may suggest opportunities the user has not yet considered, such as reconfiguring an investment portfolio to invest in fractional shares of various specific stocks in order to boost investment returns.

Additionally, the MIPA model 210 may leverage the financial status X-ray tool to present an opportunity for the user to complete one or more subgoals associated with a respective topic and/or pathway. In some examples, the MIPA model 210 may leverage generative AI and/or NLP techniques to present various opportunities to a user in a conversational manner. For example, the MIPA model 210 may be configured to generate model output (e.g., audio output, textual output, and/or visual output) related to a potential opportunity the user may be interested in such as, “I see you have extra money sitting in your low-yield checking account. You could leverage that extra money to complete one or more “to-dos” (e.g., action items) related to your education investment goal. Want to know more?”

Additionally or alternatively, as described herein, the MIPA model 210 may be configured to generate an action item list configured as a could-do list comprising various action items generated based on one or more contexts associated with a user. For example, the MIPA model 210 may be configured to generate various action items related to the potential uses for any additional or “excess” funds that have been deposited into a financial account associated with the user. For example, if the user has received funds outside of an expected amount (e.g., in addition to a known salary or income), the MIPA model 210 may generate a could-do list comprising action items related to allocating the additional funds in various ways. For example, the could-do list may comprise action items related to investing the money using an existing brokerage account associated with the user, executing a tax-loss harvesting scheme, creating a revocable trust for one or more beneficiaries, setting up automatic investment strategies, paying off a portion of a mortgage or other expenses, using the money to complete previously instantiated goals associated with an existing pathway (e.g., retirement goals, education funding goals, residence relocation goals), instantiating a preexisting scenario into a pathway, and/or the like.

In some examples, one or more action items associated with a respective could-do list may be added, removed, and/or updated based on the execution of a first action item on the respective could-do list. As such, the MIPA model 210 may be configured to continuously update the could-do list based on the current status (e.g., completion status) of the action items on the could-do list. For example, if a user elects to complete a first action item on the could-do list by utilizing excess funds that have been deposited into a financial account associated with the user, one or more action items that also require funds to complete may no longer be a viable option for the user and may be removed from the could-do list. For instance, the user may no longer have access to a required amount of funds complete a second and/or third action item on the could-do list due to spending funds while completing the first action item.

As another example, the MIPA model 210 may add one or more action items to the could-do list in response to the completion of various action items on the could-do list. For example, if the user completes a first action item on the could-do list (e.g., an action item associated with opening a line of credit), the MIPA model 210 may generate additional action items that were not previously available to the user (e.g., action items that may be completed using newly available funds associated with the newly opened line of credit). Additionally or alternatively, the MIPA model 210 may be configured to generate and/or add one or more action items to a could-do list based on the based on the completion of one or more actions on a to-do list. For example, if the MIPA model 210 has generated a to-do list for a user based on a particular topic and/or pathway that has been previously instantiated for the user, the MIPA model 210 may be configured to update a could-do list (e.g., add, remove, and/or update one or more action items) in response to the completion of one or more action items on the to-do list. In such examples, the completion of one or more action items on the to-do list may cause the MIPA model 210 identify various opportunities for the user that were not available to the user prior to the completion of various action items on the to-do list and may generate one or more action items for the could-list based on the identified opportunities.

Furthermore, in some examples, the MIPA model 210 may present one or more could-do list action items to a user within the context of foregoing and/or delaying the execution of one or more action items on a to-do list associated with a particular topic and/or pathway. For example, the MIPA model 210 may be configured to generate model output (e.g., audio output, textual output, and/or visual output) for the user such as, “You could put off doing Action Item X from To-do List A and complete Action Item Y from your Could-do List instead. Do you want to explore this option?” In such an example, if the user provides an affirmative response to the prompt provided by the MIPA model 210 (e.g., clicking a button in a user interface of a software application instance associated with the MIPA system 102, saying “yes”, or giving a “thumbs up” gesture in view of a camera associated with a smart home device), the MIPA model 210 may be configured to describe why executing the could-do list action item and delaying the to-do list action item may be more beneficial to the user at a given time.

Additionally or alternatively, the MIPA model 210 may generate and present opportunities in an opportunity reel (e.g., opportunity reel 704) that are based on the actions, goals (e.g., primary goals, subgoals), and/or verified financial outcomes of one or more members associated with the user's peer group (e.g., users associated with a same or similar income level, tax bracket, financial status, occupation, demographic, educational background, cost-of-living location). For example, the MIPA model 210 may provide model output such as, “People on your trajectory tend to diversify their investments by investing in index funds such as Fund XYZ. So, I'm thinking you could allocate around $XX.XX of your additional monthly income for investing in a few index funds commonly held by your peers. Do you want to see how this will impact your current pathways?” Depending on the response provided by the user, the MIPA model 210 may be configured to generate model output (e.g., audio output, textual output, and/or visual output) describing how investing in various index funds may impact various goals (e.g., primary goals, subgoals) the user is currently pursuing.

For example, in response to an affirmative response provided by the user (e.g., user input such as clicking a button in a user interface of a software application instance associated with the MIPA system 102, saying “yes” out loud, or giving a “thumbs up” gesture in view of a camera associated with a smart home device), the MIPA model 210 may describe and/or graphically illustrate how allocating additional money to various index investments may positively impact an early retirement goal previously set by the user (e.g., may shorten the time to retirement), whereas allocating the additional money to various index investments may adversely impact a previously set goal related to the early payoff of a mortgage related to a primary residence.

Additionally, in some examples, the MIPA model 210 may suggest opportunities that are out-of-character for the user (e.g., based on the user's historical actions and inferred character traits). For example, if user is typically risk-averse and/or debt-averse, the MIPA model 210 may present options that may be out-of-character for the user (e.g., might be perceived as relatively risky) if executing such an option might enable the user to accomplish various action items and/or subgoals associated with a particular pathway in a shorter amount of time. For instance, the MIPA model 210 may suggest that the user leverage a home equity line of credit (HELOC) associated with a primary residence and use the funds to accomplish a previously set goal (e.g., a goal to quickly pay off higher interest debt, purchase an investment property, invest in a business being run by the user, and/or the like). In such an example, the MIPA model 210 may be configured to determine an amount of credit and/or an interest rate associated with the HELOC that the user may qualify for based on data retrieved from the enterprise associated with the mortgage on the user's primary residence and/or the user's current financial status, employment status, the current value of the user's primary residence, and/or the like. In this manner, the MIPA model 210 may present dynamic opportunities that are unique to the user and will provide the most benefit based on the current financial status of the user.

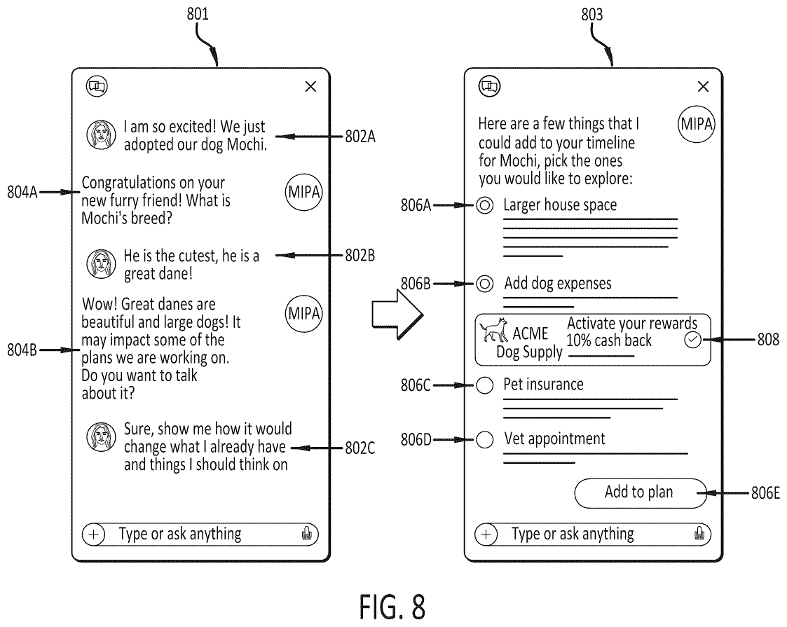

FIG. 8 illustrates additional example user interfaces of an example software application instance integrated with the MIPA model 210 configured to provide MIPA in accordance with some examples described herein. Specifically, FIG. 8 illustrates how the MIPA model 210 may acquire data related to a life event associated with a user based on a conversational interaction with the user. Additionally, FIG. 8 illustrates an example in which the MIPA model 210 may utilize data related to a life event to generate, adjust, and/or update one or more topics and/or pathways associated with a user.

As shown, a user interface (e.g., user interface 801) may be configured to display user input (e.g., user input 802A-802C) associated with a respective user, as well as model output (e.g., model output 804A-804B) generated by the MIPA model 210 in response to the user input. In some examples, various user input (e.g., user input 802A-802C) displayed via a user interface (e.g., user interface 801) may be a textual representation of audio-based user input (e.g., human speech captured by a microphone associated with a user device (e.g., user device 108A)), where the textual representation is generated by the MIPA model 210.

In the example illustrated in FIG. 8, the user input 802A provided by the user indicates that the user has recently adopted a new dog named Mochi. As described herein, the MIPA model 210 may be configured to gather user data (or additional user data) using conversational segues. A conversational segue may be a prompt (e.g., a follow-up question, a prompt, an insight, an acknowledgement) provided by the MIPA model 210 to a user in response to a user's input (e.g., a user's comment or question) and may be configured to solicit an additional response from the user and to glean additional information. For example, if a user tells the MIPA model 210 they have adopted a dog (e.g., as in user input 802A), the MIPA model 210 may use a conversational segue to prompt the user to disclose what breed of dog the user has adopted. For example, model output 804A comprised a question for the user related to the breed of the user's new dog. The user may respond with user input (e.g., user input 802B) related to the dog's breed.

In such an example, the MIPA model 210 may determine how the particular breed may impact any established pathways, goals (e.g., primary goals, subgoals), and/or opportunities currently being pursued by the user. As such, the MIPA model 210 may generate and provide model output (e.g., model output 804B) comprising a conversational segue indicating that various established pathways, goals (e.g., primary goals, subgoals), and/or opportunities associated with the user will be impacted by the breed of dog that the user has adopted (e.g., a Great Dane, which is known to be a very large breed of dog). If the MIPA model 210 receives an affirmative response from the (e.g., as in user input 802C), the MIPA model 210 may be configured to present various insights, opportunities, and/or action items that may be of interest to the user. As such, the MIPA model 210 (e.g., in conjunction with the MIPA management circuitry 208) may be configured display various interactive user interface elements (e.g., interactive user interface elements 806A-806E) associated the various insights, opportunities, and/or action items.

Based on a respective life event that a user is experiencing, the MIPA model 210 may be configured to determine various insights, opportunities, and/or action items related to one or more determined expenses, costs, requirements, restrictions, necessities, best practices, related services, and/or the like that a user may have to manage based on the respective life event. For example, as shown on the user interface 803, the MIPA model 210 may determine how a life event (e.g., adopting a large breed of dog) may impact a user's living situation, monthly expenses, insurance needs, and/or medical (e.g., veterinarian) needs.

As an example, if a user has an established pathway associated with purchasing a new home in a different living location and has indicated that they are interested in a particular style of accommodation (e.g., a one-bedroom apartment), the MIPA model 210 may determine that a particular life event (e.g., adopting a large breed of dog) may require that the user purchase a home with more space than the user initially planned for. By way of continued example, the MIPA model 210 may also be configured to estimate various monthly expenses associated with the user's life event (e.g., adopting a large breed of dog) that may be associated with various routine costs (e.g., dietary needs, medical needs, equipment needs, increased resource consumption) associated with the life event.

In this example, the MIPA model 210 may also determine various insurance needs (e.g., pet insurance) the user may encounter due to the life event (e.g., adopting a large breed of dog). As such, the MIPA model 210 may be configured to retrieve various insurance data to provide insights and/or action items related to various insurance needs (e.g., pet insurance) to the user. The MIPA model 210 may also be configured to determine and arrange various healthcare needs (e.g., veterinarian needs) for the user based on the life event the user is experiencing (e.g., adopting a large breed of dog). As such, the MIPA model 210 may be configured to identify various healthcare professionals (e.g., veterinarians) associated with a particular living location (e.g., a potential living location the user may be relocating to). Furthermore, the MIPA model 210 may be configured to schedule one or more appointments on behalf of the user (e.g., veterinarian appointments) based on the data the MIPA model 210 has obtained from the user based on one or more interactions with the user.

In addition to generating various insights, action items, and/or opportunities for a user based on one or more respective life events the user is experiencing, the MIPA model 210 may be configured to identify and present various products and/or product offers related to the one or more respective life events to a user. In this regard, the MIPA model 210 (e.g., in conjunction with the MIPA management circuitry 208) may generate an imprint (e.g., imprint 808) associated with a respective product or product offer that may be relevant to a life event a respective user is experiencing. For example, as shown on user interface 803, the imprint 808 indicates a cash back rewards program associated with a pet supply store that the user in the illustrated example may take advantage of if the user so chooses. In an example in which the user opts to take advantage of an offer and/or product associated with an imprint (e.g., imprint 808) displayed on a user interface (e.g., user interface 803), the MIPA model 210 may be configured to place one or more product orders, open an account (e.g., a store account), and/or provide various user information (e.g., credit card information, contact information) to a company, business, store, organization, and/or the like associated with the imprint on the behalf of the user in order to acquire a product offer and/or product associated with imprint.

As will be appreciated, various user interactions other than the one used as an example in FIG. 8 may achieve similar results. For example, a respective user may indicate to the MIPA model 210 that the user is experiencing one or more life events such as getting divorced, receiving a large gift (e.g., a boat) that may incur additional expenses (e.g., storage, maintenance, upkeep), becoming a primary caregiver for a loved one (e.g., a family member), and/or the like. In such examples, the MIPA model 210 may utilize conversational segues to obtain additional information from the user related to the one or more respective life events. Additionally, the MIPA model 210 may calculate various additional expenses, costs, and/or time commitments associated with the one or more life events. As such, the MIPA model 210 may determine how the one or more life events may impact the user's financial status and/or one or more established pathways associated with the user.

For example, the MIPA model 210 may be configured to determine a predicted impact to a user's income and/or working schedule based on the user's assumption of the role of primary caregiver for a loved one. As another example, the MIPA model 210 may determine one or more impacts to a user's routine income and/or living expenses based on an indication that the user is going through a divorce. In such an example, the MIPA model 210 may be configured to determine that the user may be liable for alimony payments, lawyer fees, court fees, and/or the like, and/or that the user will no longer be associated with a two-income household. Such life events may change the timeline and/or feasibility of completing one or more established pathways associated with a respective user such that the user may have to adjust one or more goals (e.g., primary goals, subgoals) and/or pursue different goals entirely. As such, the MIPA model 210 may be configured to assist the user in navigating such life events by determining a user's new (or future) financial status based on experiencing a respective life event and generating one or more pathways, action items, and/or opportunities for the user based on the user's new (or future) financial status.

### Example Operations

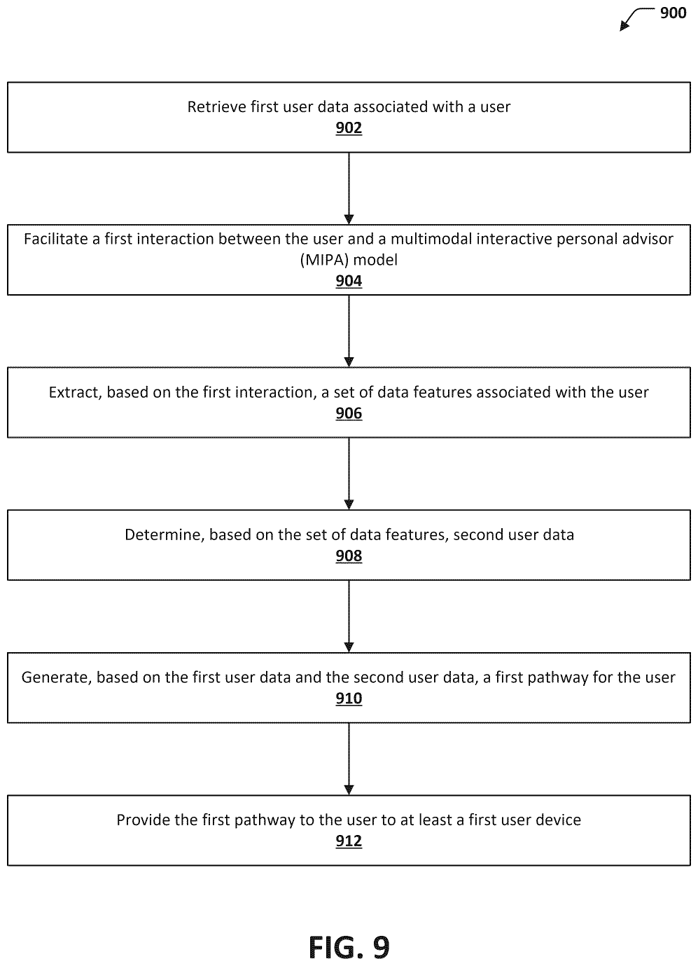

Turning to FIGS. 9-13, example flowcharts are illustrated that contain example operations implemented by examples described herein. The operations illustrated in FIGS. 3-13 may, for example, be performed by a system device (e.g., server) of the MIPA system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, MIPA management circuitry 208, MIPA model 210, user data circuitry 212, external data circuitry 214, and/or any combination thereof. It will be understood that user interactions with the MIPA system 102 may occur directly via communications hardware 206 or may instead be facilitated by a separate computing device (e.g., any of enterprise computing devices 106A-106N, and/or user devices 108A-108N shown in FIG. 1), and which may have similar or equivalent physical componentry for facilitating such user interactions.

Turning first to FIG. 9, the flowchart 900 illustrates example operations for generating a pathway for a respective user.

As shown by operation 902, the apparatus 200 may include means, such as user data circuitry 212, MIPA model 210, and/or the like for retrieving first user data associated with a user. As described herein, the MIPA model 210 may be configured to leverage the user data circuitry 212 to gather user data associated with the user from one or more of an email account, financial account (e.g., banking account, credit account, investment account), user account associated with various enterprises (e.g., financial institutions, businesses, organizations), social media account, and/or the like. As such, the first user data may be associated with one or more of financial data, PII, demographic information, personal relationship data, life event data, behavioral data, cost-of-living data, user device data, and/or social media data associated with the user.

As shown by operation 904, the apparatus 200 may include means, such as MIPA model 210 and/or the like for facilitating a first interaction between the user and an MIPA model (e.g., MIPA model 210). In some examples, the first interaction may comprise one or more of a conversational interaction, a documentation upload interaction, and/or a video-based interaction. For example, the user may converse with the MIPA model 210 in an audio- and/or video-based interaction via a user device (e.g., user device 108A) during the first interaction. In this regard, the MIPA model 210 may comprise one or more speech models configured to generate conversational model output in response to conversational user input (e.g., human speech) generated by the user. Additionally or alternatively, the user may upload documentation (e.g., an email, a scanned document) during the first interaction by utilizing a software application instance associated with the MIPA system 102 (e.g., a mobile application executed via the user device 108A).

In this regard, facilitation of the first interaction may cause the MIPA model 210 to generate one or more conversational segues and provide the one or more conversational segues to the user (e.g., in an audio format, a visual format) in order to solicit user input from the user. In some examples, the MIPA model 210 may be receive solicited user input provided in response to the one or more conversational segues, where the solicited user input may be configured in a variety of formats (e.g., text-, audio-, and/or video-based user input).

Additionally or alternatively, in some examples, the MIPA model 210 may be configured to generate intentionally incorrect user data, where the MIPA management circuitry 208 may be configured to provide the intentionally incorrect user data to the user in order to solicit user input from the user. In such examples, the MIPA model 210 may be configured to receive solicited user input provided by the user in response to the intentionally incorrect user data and extract one or more data features of the set of data features from the second solicited user input.

As shown by operation 906, the apparatus 200 may include means, such as MIPA model 210 and/or the like for extracting, based on the first interaction, a set of data features associated with the user. In various examples, the set of data features may comprise one or more text data features, text placement data features, text format data features (e.g., fonts, emphasis, styles), image data features, and/or scannable imprint features hyperlink data features, interactive user interface element data features, image metadata features, and/or the like associated with documentation uploaded by the user. Additionally or alternatively, the set of data features may comprise one or more of acoustic feature data, valence data, arousal data, dominance data, intensity data, intonation data, speech rate data, MFCC data, and/or the like associated with audio data input.

Additionally or alternatively, as described herein, the MIPA model 210 may be configured to employ one or more NLP techniques to extract one or more utterances, words, sentences, phrases, and/or the like from audio data input provided by a respective user in order to determine the context, meaning, emotion, and/or intention associated with various speech input provided by the user. Additionally or alternatively, the set of data features may comprise one or more of body features, facial feature data, facial expression data, eye feature data, eye movement data, body posture data, hand gesture data, sign language data, and/or the like from image data (e.g., video data, still image data).

In some examples, the MIPA model 210 may be configured to extract one or more data features of the set of data features from solicited user input. For example, as described herein, the MIPA model 210 may be configured to solicit user input by generating various conversational segues and/or providing the user with intentionally incorrect user data to the user.

As shown by operation 908, the apparatus 200 may include means, such as MIPA model 210 and/or the like for determining, based on the set of data features, second user data associated with the user. As described herein, the second user data may be associated with one or more of financial data, PII, demographic information, personal relationship data, life event data, behavioral data, cost-of-living data, user device data, and/or social media data associated with the user.

The first user data and/or the second user data may be utilized by the MIPA model 210 to generate and/or update a user profile associated with the user. Additionally or alternatively, the MIPA model 210 may be configured to determine, based on the first user data and the second user data, a financial status of the user. In some examples, the financial status of the user may be a current financial status. In other examples, the financial status of the user may be a future (e.g., predicted, inferred) financial status of the user.

As shown by operation 910, the apparatus 200 may include means, such as MIPA model 210 and/or the like for generating, based on the first user data and the second user data, a first pathway for the user. As described herein, the first pathway may be an actionable plan associated with one or more of a primary goal, a set of subgoals related to the primary goal, a set of insights, a set of important considerations, a set of product offers, a set of opportunities, a set of scenarios, a set of action item lists, and/or a set of tradeoffs.

In some examples, generation of the first pathway comprises generating, based on the set of data features extracted from the first interaction, a first topic associated with the first pathway. As described herein, the first topic may be a categorical electronically managed data structure, and the MIPA model 210 may be configured to cause storage of the first topic in a user profile associated with the user. Additionally or alternatively, in some examples, generation of the first pathway comprises generating a first action item list associated with the first pathway, where the first action item list comprises a first set of action items. As described herein, the MIPA model 210 may be configured to execute one or more actions items of the first set of action items associated with first pathway on behalf of the user. In some examples, the MIPA model 210 may identify one or more appropriate sub-agents 211A-211N to execute one or more actions items of the first set of action items associated with first pathway on behalf of the user.

In some examples, the first pathway may be generated based in part on the first pathway is generated based on external data, where the external data comprises one or more of legislative data, tax data, real estate data, financial data, market data, peer group data, living location data, cost-of-living data, news data, current event data, product data and/or product offer data. Additionally or alternatively, the MIPA model 210 may be configured to determine a set of missing user data in the first user data or the second user data and generate, based on the peer group data, inferred user data. In some examples, the first pathway may be generated based on the inferred user data. Additionally or alternatively, the first pathway may be generated based on the current and/or future (e.g., predicted, inferred) financial status of the user.

As shown by operation 912, the apparatus 200 may include means, such as MIPA management circuitry 208 and/or the like for providing the first pathway to at least a first user device associated with the user. As described herein, the MIPA management circuitry 208 may be configured to generate various user interfaces associated with a software application instance integrated with the MIPA system 102. In addition to enabling the user to interact with the MIPA model 210, the software application instance may be configured to output various images, text, graphics, visualizations, digital media content (e.g., audio content, video content), and/or the like. Additionally, the software application instance associated with the MIPA system 102 may be configured to display various interactive user interface elements configured to enable a user to interact with the MIPA model 210 and/or various data related to one or more topics, pathways, goals, opportunities, tradeoffs, action item lists, financial outlook tools, cost-of-living impact tools, financial status X-ray tools, and/or the like.

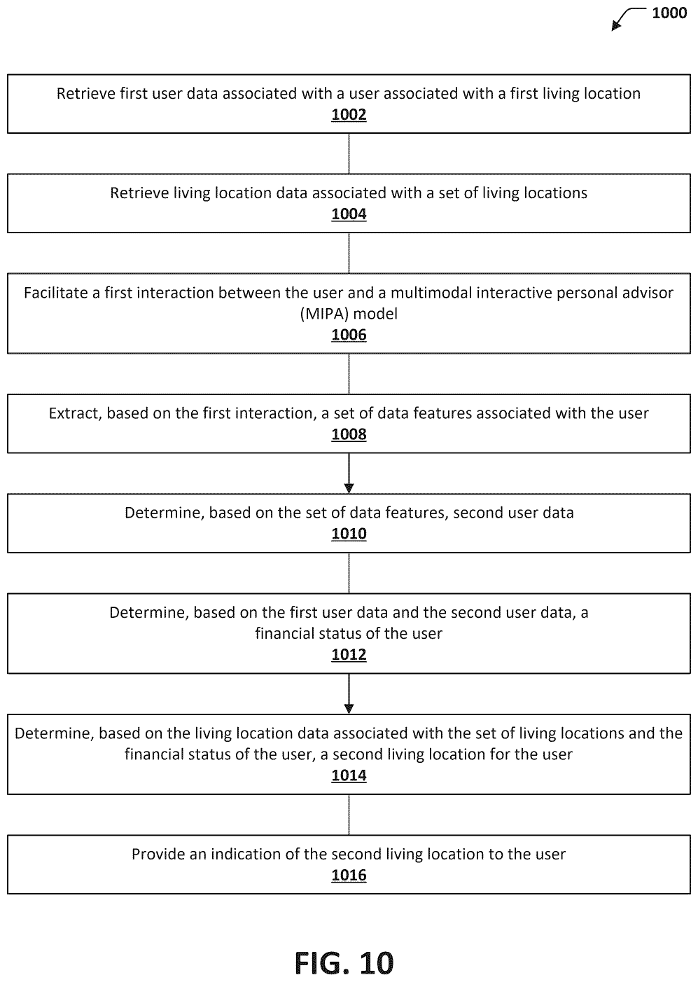

Turning next to FIG. 10, the flowchart 1000 illustrates example operations for determining a living location for a user based on a financial status of the user. In some examples, the operations described with reference to FIG. 10 may be example operations associated with a cost-of-living impact tool associated with the MIPA system 102.

As shown by operation 1002, the apparatus 200 may include means, such as communications hardware 206, user data circuitry 212, and/or the like for retrieving first user data associated with a user, where the user is associated with a first living location (e.g., a geolocation, city, neighborhood, district, borough, county, and/or the like to which the user may relocate).

As shown by operation 1004, the apparatus 200 may include means, such as communications hardware 206, external data circuitry 214, and/or the like for retrieving living location data associated with a set of living locations. As described herein, living location data may comprise various living location attributes including one or more of transit score data, safety data (e.g., crime rate data), walkability data (e.g., data related to how walkable a location is), work commute distance (e.g., based on location of new job), population density data, resident income data, property cost data (e.g., average rental costs, home ownership costs, property taxes, utility costs), and/or the like.

As shown by operation 1006, the apparatus 200 may include means, such as MIPA management circuitry 208 and/or the like for facilitating a first interaction between the user and an MIPA model (e.g., MIPA model 210). As described herein, the first interaction may comprise one or more of a conversational interaction, a documentation upload interaction, and/or a video-based interaction.

As shown by operation 1008, the apparatus 200 may include means, such as MIPA model 210 and/or the like for extracting, based on the first interaction, a set of data features associated with the user. In various examples, the set of data features may comprise one or more text data features, text placement data features, text format data features (e.g., fonts, emphasis, styles), image data features, and/or scannable imprint features hyperlink data features, interactive user interface element data features, image metadata features, and/or the like associated with documentation uploaded by the user. Additionally or alternatively, the set of data features may comprise one or more of acoustic feature data, valence data, arousal data, dominance data, intensity data, intonation data, speech rate data, MFCC data, and/or the like associated with audio data input.

As shown by operation 1010, the apparatus 200 may include means, such as MIPA model 210 and/or the like for determining, based on the set of data features, second user data associated with the user. As described herein, the second user data may be associated with one or more of financial data, PII, demographic information, personal relationship data, life event data, behavioral data, cost-of-living data, user device data, and/or social media data associated with the user.

As shown by operation 1012, the apparatus 200 may include means, such as MIPA model 210 and/or the like for determining, based on the first user data and the second user data, a financial status of the user. A user's financial status may be associated with various financial data such as data related to banks accounts, transaction history, deposit history, investment portfolio performance, investment dividends, beneficiary data, credit data, mortgage data, debt data, and/or the like. A financial status may also indicate where certain funds are coming from (e.g., salary, dividends) and/or being allocated to (e.g., expenses, debt, investments, goals). In some examples, the MIPA model 210 may be configured to determine a current financial status associated with the user based on the first user data and/or the second user data. Additionally or alternatively, the MIPA model 210 may be configured to predict or infer a future financial status associated with the user based on the first user data and/or the second user data.

As shown by operation 1014, the apparatus 200 may include means, such as MIPA model 210 and/or the like for determining, based on the living location data associated with the set of living locations and the financial status of the user, a second living location for the user. In some examples, the MIPA model 210 may be configured to receive living location data for each living location in a set of living locations and rank each living location of the set of living locations based on a set of living location attributes associated with the living location data. The MIPA model 210 may then determine the second living location based on determining the second living location has a highest rank out of each living location.

A respective living location attribute may be associated with a respective score or percentage (e.g., a numerical value, numerical grade, numerical range) that indicates a qualitative metric associated with the respective living location attribute. In some examples, a score or percentage associated with a respective living location attribute may be a relative score or relative percentage generated based on one or more national and/or local averages, such that a higher relative score or relative percentage may indicate that a first living location is more desirable than one or more other living locations. In some examples, the set of living location attributes may comprise one or more of transit score data, safety data, walkability data, work commute distance, population density data, resident income data, or property cost data associated with each living location of the set of living locations.

In some examples, the MIPA model 210 is configured to determine, based on one or more of the first user data or the second user data, that the user has accepted a new job role associated with a living location that is different from the first living location. As such, the MIPA model 210 may determine the second living location based in part on determining a respective living location associated with the new job role. For example, the MIPA model 210 may determine that the second living location is a highest ranked living location within a predetermined distance from the respective living location associated with the new job role.

As shown by operation 1016, the apparatus 200 may include means, such as MIPA management circuitry 208 and/or the like for providing an indication of the second living location to the user. For example, the MIPA management circuitry 208 may provide various data associated with the second living location to the user via one or more user interfaces (e.g., user interface 505) associated with a cost-of-living impact tool. For example, the MIPA management circuitry 208 may be configured to generate interactive map associated with the set of living locations and render various living location data associated with the second living location on the interactive map.

Additionally, as described herein, the MIPA model 210 may be configured to determine an expected buying power of the user, where the expected buying power of the user is determined based on first living location data associated with the first living location, second living location data associated with the second living location, and the financial status of the user. In such examples, the MIPA management circuitry 208 may be configured to generate a buying power visualization based on the expected buying power and provide the buying power visualization to the user (e.g., via a user interface associated with a software application instance related to the MIPA system 102). Additionally, in some examples, the expected buying power is determined based on one or more of an average annual income associated with the second living location, estimated taxes associated with the second living location, and/or estimated living expenses associated with the second living location.

Furthermore, the MIPA model 210 may be configured to determine a set of opportunities for the user based on the expected buying power. For example, as described herein, the MIPA model 210 may factor in any additional monthly income the user may acquire by accepting a particular job in the second living location (e.g., a destination living location) when determining the buying power and/or generating various pathways, goals (e.g., primary goals, subgoals), action items, opportunities, and/or the like for the user. For example, the MIPA model 210 may generate model output (e.g., model output 502A) associated with various insights related to an increased buying power (e.g., a 61% relative increase in buying power) the user may experience based on an expected salary (e.g., $55,000 annually) the user will make in the second living location.

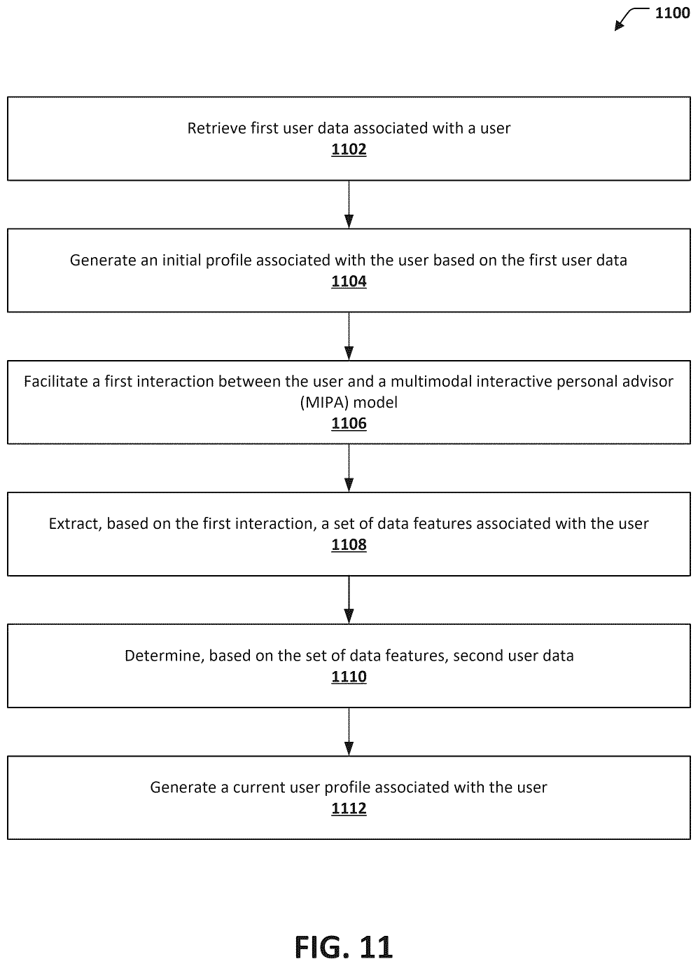

Turning next to FIG. 11, the flowchart 1100 illustrates example operations for continuously configuring a user profile associated with a user.

As shown by operation 1102, the apparatus 200 may include means, such as communications hardware 206, user data circuitry 212, external data circuitry 214, and/or the like for retrieving first user data associated with a user.

As shown by operation 1104, the apparatus 200 may include means, such as MIPA management circuitry 208, MIPA model 210, and/or the like for generating an initial user profile associated with the user based on the first user data. As described herein, a respective MIPA model 210 associated with a particular user may be configured such that no manual configuration is required from the user upon the setup, initialization, or initial configuration of the respective MIPA model 210. Instead, the MIPA model 210 may generate an initial user profile or account on the backend by aggregating enterprise data and/or user data from multiple sources.

Additionally, the MIPA management circuitry 208 may be configured to train a suite of ML models (e.g., sub-agents 211A-211N) associated with the MIPA model 210 based on the initial user profile associated with the user. In some examples, the suite of ML models (e.g., sub-agents 211A-211N) may comprise one or more of a predictive model, a descriptive model, a prescriptive model, and/or the like. As described herein, the MIPA model 210 may manage, direct, leverage, and/or otherwise integrate with the suite of ML models. For example, as described herein, the MIPA model 210 may determine (e.g., infer) a set of character traits associated with the user. The MIPA model 210 may leverage the predictive model of the suite of ML models to predict one or more user actions that the user may execute based on the set of character traits.

As another example, the MIPA model 210 may be configured to receive external data relevant to the user, wherein the external data comprises peer group data related to a peer group associated with the user. The MIPA model 210 may determine a set of missing user data in the current user profile and leverage the descriptive model of the suite of ML models (e.g., sub-agents 211A-211N) to generate inferred user data associated with the user based on the peer group data. In some such examples, the descriptive model of the suite of ML models may be configured to cluster the user with one or more peers of the peer group, where the one or more peers are similar to the user (e.g., users associated with a same or similar income level, tax bracket, financial status, occupation, demographic, educational background, cost-of-living location). As such, the descriptive model may be configured to generate the inferred user data based on the peer group data associated with the one or more peers.

As another example, the MIPA model 210 may be configured to leverage the prescriptive model of the suite of ML models to determine, based on a financial status of the user, one or more opportunities for the user, where the MIPA management circuitry 208 is configured to provide the one or more opportunities (e.g., one or more action items the user may desire to execute with various funds) to the user via a user device (e.g., user device 108A) associated with the user.

Additionally, in some examples, the MIPA model may be configured to determine, based on an interaction with the user, that a life event associated with the user has occurred (e.g., divorce, loss of a job, loss of a dependent). In some examples, the life event may be associated with a change in a mindset, a pathway, a goal, a financial outlook, and/or a financial status of the user. In such examples, the MIPA management circuitry 208 may be configured to revert one or more of the MIPA model 210, the predictive model, the descriptive model, and/or the prescriptive model associated with the suite of models to a respective historical model configuration. In this regard, the MIPA management circuitry 208 may be configured to log various model configurations and/or states associated with any of the one or more models associated with the MIPA system 102 such that one or more of the models may be reverted to an earlier configuration and/or state.

As shown by operation 1106, the apparatus 200 may include means, such as MIPA management circuitry 208 and/or the like for facilitating a first interaction between the user and an MIPA model (e.g., MIPA model 210). As described herein, the first interaction may comprise one or more of a conversational interaction, a documentation upload interaction, and/or a video-based interaction.

As shown by operation 1108, the apparatus 200 may include means, such as MIPA model 210 and/or the like for extracting, based on the first interaction, a set of data features associated with the user. In various examples, the set of data features may comprise one or more text data features, text placement data features, text format data features (e.g., fonts, emphasis, styles), image data features, and/or scannable imprint features hyperlink data features, interactive user interface element data features, image metadata features, and/or the like associated with documentation uploaded by the user. Additionally or alternatively, the set of data features may comprise one or more of acoustic feature data, valence data, arousal data, dominance data, intensity data, intonation data, speech rate data, MFCC data, and/or the like associated with audio data input.

As shown by operation 1110, the apparatus 200 may include means, such as MIPA model 210 and/or the like for determining, based on the set of data features, second user data associated with the user. As described herein, the second user data may be associated with one or more of financial data, PII, demographic information, personal relationship data, life event data, behavioral data, cost-of-living data, user device data, and/or social media data associated with the user.

As shown by operation 1112, the apparatus 200 may include means, such as MIPA management circuitry 208, MIPA model 210, and/or the like for generating a current profile associated with the user. In some examples, the current user profile is generated based on updating the initial user profile based on the second user data. In this regard, once the initial user profile associated with the user is generated, the initial user profile may be continuously modified based on one or more interactions between the user and the MIPA model 210.

In some examples, the MIPA model 210 may be configured to update the current user profile based on inferred user data generated by the descriptive model of the suite of ML models. Additionally or alternatively, the MIPA model 210 may be configured to update the current user profile based on one or more life events associated with the user. Furthermore, the MIPA management circuitry 208 may be configured to update the suite of ML models based on the current user profile such that the one or more ML models associated with the suite of ML models remains configured to generate accurate predictions, accurate inferences, appropriate opportunities, and/or other relevant model output for the user over time.

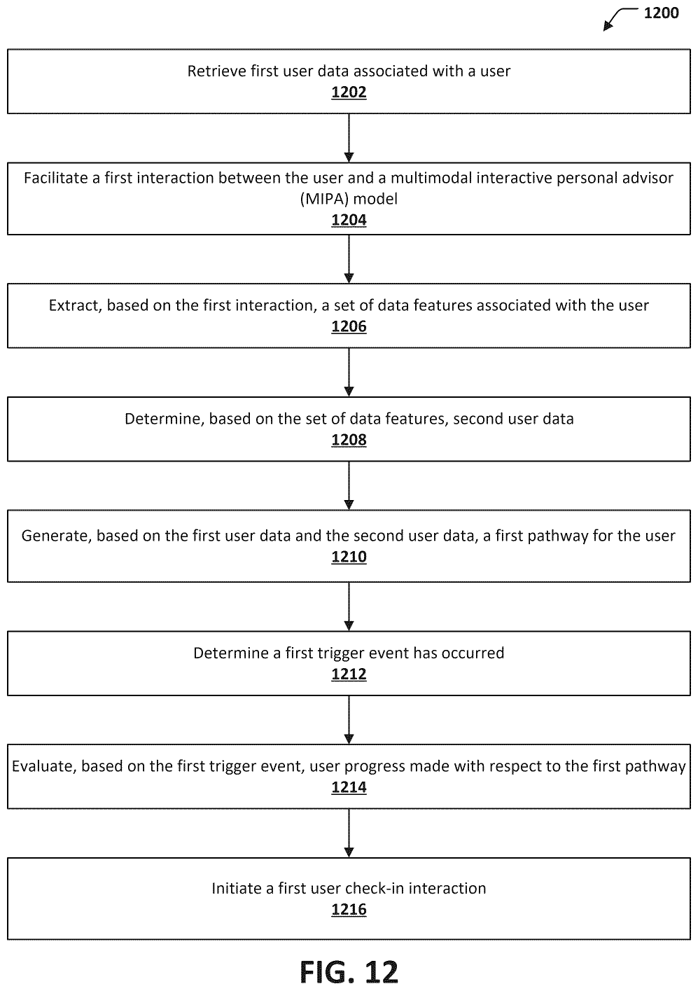

Turning next to FIG. 12, the flowchart 1200 illustrates example operations for executing a user check-in interaction.

As shown by operation 1202, the apparatus 200 may include means, such as communications hardware 206, user data circuitry 212, external data circuitry 214, and/or the like for retrieving first user data associated with a user. As described herein, the MIPA model 210 may be configured to leverage the user data circuitry 212 to gather user data associated with the user from one or more of an email account, financial account (e.g., banking account, credit account, investment account), user account associated with various enterprises (e.g., financial institutions, businesses, organizations), social media account, and/or the like. As such, the first user data may be associated with one or more of financial data, PII, demographic information, personal relationship data, life event data, behavioral data, cost-of-living data, user device data, and/or social media data associated with the user.

As shown by operation 1204, the apparatus 200 may include means, such as MIPA management circuitry 208, and/or the like for facilitating a first interaction between the user and an MIPA model (e.g., MIPA model 210). As shown by operation 904, the apparatus 200 may include means, such as MIPA model 210 and/or the like for facilitating a first interaction between the user and an MIPA model (e.g., MIPA model 210). In some examples, the first interaction may comprise one or more of a conversational interaction, a documentation upload interaction, and/or a video-based interaction. For example, the user may converse with the MIPA model 210 in an audio- and/or video-based interaction via a user device (e.g., user device 108A) during the first interaction. In this regard, the MIPA model 210 may comprise one or more speech models configured to generate conversational model output in response to conversational user input (e.g., human speech) generated by the user. Additionally or alternatively, the user may upload documentation (e.g., an email, a scanned document) during the first interaction by utilizing a software application instance associated with the MIPA system 102 (e.g., a mobile application executed via the user device 108A).

As shown by operation 1206, the apparatus 200 may include means, such as MIPA model 210 and/or the like for extracting, based on the first interaction, a set of data features associated with the user. In various examples, the set of data features may comprise one or more text data features, text placement data features, text format data features (e.g., fonts, emphasis, styles), image data features, and/or scannable imprint features hyperlink data features, interactive user interface element data features, image metadata features, and/or the like associated with documentation uploaded by the user. Additionally or alternatively, the set of data features may comprise one or more of acoustic feature data, valence data, arousal data, dominance data, intensity data, intonation data, speech rate data, MFCC data, and/or the like associated with audio data input.

Additionally or alternatively, as described herein, the MIPA model 210 may be configured to employ one or more NLP techniques to extract one or more utterances, words, sentences, phrases, and/or the like from audio data input provided by a respective user in order to determine the context, meaning, emotion, and/or intention associated with various speech input provided by the user. Additionally or alternatively, the set of data features may comprise one or more of body features, facial feature data, facial expression data, eye feature data, eye movement data, body posture data, hand gesture data, sign language data, and/or the like from image data (e.g., video data, still image data).

As shown by operation 1208, the apparatus 200 may include means, such as MIPA model 210 and/or the like for determining, based on the set of data features, second user data associated with the user. As described herein, the second user data may be associated with one or more of financial data, PII, demographic information, personal relationship data, life event data, behavioral data, cost-of-living data, user device data, and/or social media data associated with the user.

As shown by operation 1210, the apparatus 200 may include means, such as MIPA model 210 and/or the like for generating, based on the first user data and the second user data, a first pathway for the user. As described herein, the first pathway may be an actionable plan associated with one or more of a primary goal, a set of subgoals related to the primary goal, a set of insights, a set of important considerations, a set of product offers, a set of opportunities, a set of scenarios, a set of action item lists, and/or a set of tradeoffs.

In some examples, generation of the first pathway comprises generating, based on the set of data features extracted from the first interaction, a first topic associated with the first pathway. As described herein, the first topic may be a categorical electronically managed data structure, and the MIPA model 210 may be configured to cause storage of the first topic in a user profile associated with the user. Additionally or alternatively, in some examples, generation of the first pathway comprises generating a first action item list associated with the first pathway, where the first action item list comprises a first set of action items. As described herein, the MIPA model 210 may be configured to execute one or more actions items of the first set of action items associated with first pathway on behalf of the user.

In some examples, the first pathway may be generated based in part on the first pathway is generated based on external data, where the external data comprises one or more of legislative data, tax data, real estate data, financial data, market data, peer group data, living location data, cost-of-living data, news data, current event data, product data and/or product offer data. Additionally or alternatively, the MIPA model 210 may be configured to determine a set of missing user data in the first user data or the second user data and generate, based on the peer group data, inferred user data. In some examples, the first pathway may be generated based on the inferred user data. Additionally or alternatively, the first pathway may be generated based on the current and/or future (e.g., predicted, inferred) financial status of the user.

As shown by operation 1212, the apparatus 200 may include means, such as MIPA model 210 and/or the like for determining a first trigger event has occurred.

In some examples, the first trigger event may be a financial event. A financial event may be associated with one or more of a mortgage payment, a debt payment, a receipt of income, receipt of dividends, receipt of government disbursements, an opening of a new financial account, and/or an opening of a new financial loan. Alternatively, in some examples, the first trigger event may be a behavioral event. A behavioral event may be associated with one or more of travel data (e.g., indicating travel and/or accommodation booking), user device location data (e.g., GPS coordinate data indicating the user is not in a typical location), and/or social media data. In some examples, the first trigger event may be a combination of a financial event and a behavioral event.

As shown by operation 1214, the apparatus 200 may include means, such as MIPA model 210 and/or the like for evaluating, based on the first trigger event, user progress made with respect to the first pathway. For example, the MIPA model 210 may be configured to continuously evaluate the impact of various events (e.g., trigger events, life events, and/or the like) on the progress of any established pathways associated with the user. In this regard, the MIPA model 210 may be configured to determine, based on the first trigger event, one or more adverse impacts on the user progress made with respect to the first pathway. For example, if a user experiences a life event (e.g., a medical emergency, catastrophic event (e.g., storm, tornado) related to a property) that requires the user to make an unexpected payment (e.g., medical bills, contractor payments), the MIPA model 210 may be configured to determine how the unexpected payment will affect various established pathways associated with the user.

Additionally, in some examples, the MIPA model 210 may be configured to generate a user summary associated with the user, where the user summary is associated with one or more of a financial status, a set of inferred character traits, or a set of instantiated pathways associated with the user. In some examples, the MIPA model 210 may generate and/or provide the user summary to the user (e.g., via one or more user devices 108A-108N) in response to user input (e.g., text-based input and/or speech input) provided by the user during a user check-in interaction. For example, the user may prompt the MIPA model 210 with a query such as, “Tell me what you think of me.” In response to such a query, the MIPA model 210 may be configured to generate and provide a user summary comprising various model output that describes a general overview of the user and/or the user's goals. In such an example, the user may be enabled to confirm, deny, and/or update various data that has been cataloged, inferred, predicted, and/or otherwise generated by the MIPA model 210 during the user check-in interaction.

As shown by operation 1216, the apparatus 200 may include means, such as MIPA model 210 and/or the like for initiating a first user check-in interaction, where the first user check-in interaction comprises providing an evaluation of the user progress made with respect to the first pathway. In some examples, the first user check-in interaction may comprise one or more of a conversational interaction, a documentation upload interaction, and/or a video-based interaction. Additionally or alternatively, the first user check-in may comprise various audio-based, text-based, and/or or graphics-based model output generated by the MIPA model 210. For example, the MIPA model 210 may be configured to provide one or more recommendations to mitigate the one or more adverse impacts on various user progress made with respect to the first pathway during the first user check-in interaction. For instance, the MIPA model 210 may identify various opportunities (e.g., medical disability programs, state-funded disaster relief programs) that the user may be able to utilize to mitigate the one or more adverse impacts.

Additionally or alternatively, the MIPA model 210 may utilize the first user check-in interaction to prompt the user to confirm one or more of a goal, objective, interest, and/or desire of the user. In this regard, the MIPA model 210 may be configured to continuously monitor the user's ambitions in order to ensure that the MIPA model 210 generates appropriate pathways and/or the like for the user. Additionally or alternatively, the MIPA model 210 may utilize the first user check-in interaction to provide the user summary to the user. As such, the MIPA model 210 may be configured to receive user input generated during the first user check-in interaction based on various model output generated during the first user check-in interaction. Furthermore, the MIPA model 210 may be configured to update, based on the user input, one or more of a financial status, a set of inferred character traits, and/or a set of instantiated pathways associated with the user.

In some examples, the MIPA model 210 may utilize one or more user check-in interactions to determine various actions the user has executed individually without the use of the MIPA system 102. For example, the MIPA model 210 may initiate a second user check-in interaction based on determining a second interaction with the user is a documentation upload interaction. In such an example, the MIPA model 210 may be configured to confirm, during the second user check-in interaction, one or more actions the user has executed in response to receiving one or more documents associated with the documentation upload interaction. For example, if the user has received and uploaded documentation to the MIPA system 102 that is related to a university acceptance letter, the MIPA model 210 may initiate a user check-in interaction to determine if the user has executed any actions that may impact various established pathways. For instance, the MIPA model 210 may utilize the second user check-in interaction to determine whether the user has accepted an offer from the university, scheduled a tour with the university, and/or made any commitments and/or plans based on the uploaded documentation. Based on any user input received during the second user check-in interaction, the MIPA model 210 may generate and/or adjust one or more pathways, goals, opportunities, action items, and/or the like on the user's behalf.

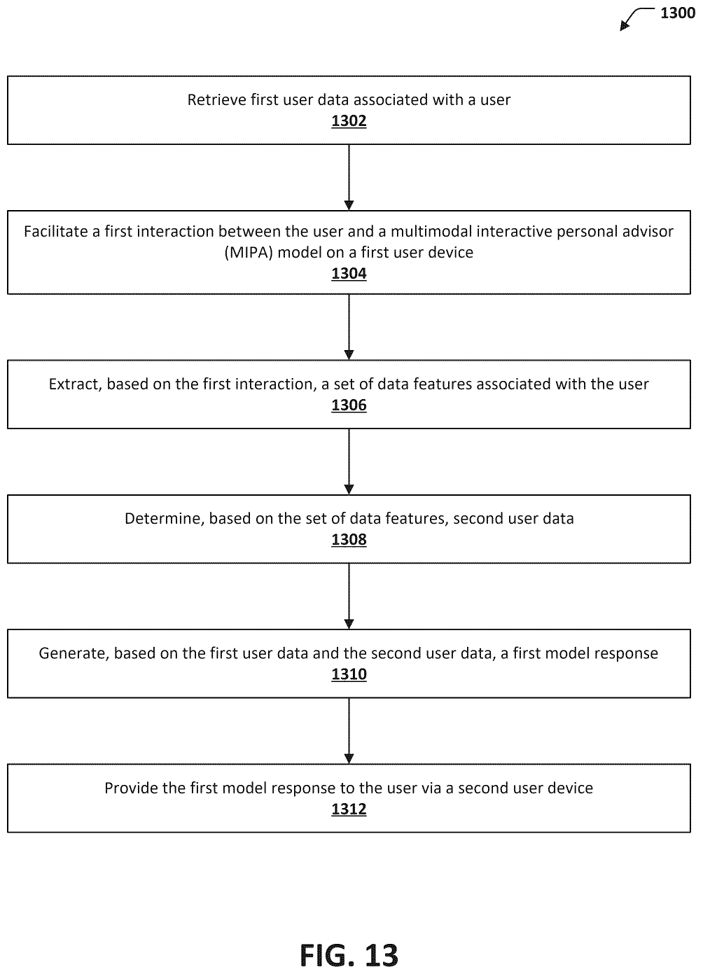

Turning next to FIG. 13, the flowchart 1300 illustrates example operations for generating and providing various model responses via multiple user devices.

As shown by operation 1302, the apparatus 200 may include means, such as communications hardware 206, user data circuitry 212, external data circuitry 214, and/or the like for retrieving first user data associated with a user. As described herein, the MIPA model 210 may be configured to leverage the user data circuitry 212 to gather user data associated with the user from one or more of an email account, financial account (e.g., banking account, credit account, investment account), user account associated with various enterprises (e.g., financial institutions, businesses, organizations), social media account, and/or the like. As such, the first user data may be associated with one or more of financial data, PII, demographic information, personal relationship data, life event data, behavioral data, cost-of-living data, user device data, and/or social media data associated with the user.

As shown by operation 1304, the apparatus 200 may include means, such as MIPA management circuitry 208 and/or the like for facilitating a first interaction between the user and an MIPA model (e.g., MIPA model 210) on a first user device (e.g., user device 108A) associated with the user. In some examples, the first interaction may comprise one or more of a conversational interaction, a documentation upload interaction, and/or a video-based interaction. For example, the user may converse with the MIPA model 210 in an audio- and/or video-based interaction via a user device (e.g., user device 108A) during the first interaction. In this regard, the MIPA model 210 may comprise one or more speech models configured to generate conversational model output in response to conversational user input (e.g., human speech) generated by the user. Additionally or alternatively, the user may upload documentation (e.g., an email, a scanned document) during the first interaction by utilizing a software application instance associated with the MIPA system 102 (e.g., a mobile application executed via the user device 108A).

As shown by operation 1306, the apparatus 200 may include means, such as MIPA model 210 and/or the like for extracting, based on first user input received during the first interaction, a first set of data features associated with the user. In various examples, the set of data features may comprise one or more text data features, text placement data features, text format data features (e.g., fonts, emphasis, styles), image data features, and/or scannable imprint features hyperlink data features, interactive user interface element data features, image metadata features, and/or the like associated with documentation uploaded by the user. Additionally or alternatively, the set of data features may comprise one or more of acoustic feature data, valence data, arousal data, dominance data, intensity data, intonation data, speech rate data, MFCC data, and/or the like associated with audio data input.

Additionally or alternatively, as described herein, the MIPA model 210 may be configured to employ one or more NLP techniques to extract one or more utterances, words, sentences, phrases, and/or the like from audio data input provided by a respective user in order to determine the context, meaning, emotion, and/or intention associated with various speech input provided by the user. Additionally or alternatively, the set of data features may comprise one or more of body features, facial feature data, facial expression data, eye feature data, eye movement data, body posture data, hand gesture data, sign language data, and/or the like from image data (e.g., video data, still image data).

As shown by operation 1308, the apparatus 200 may include means, such as MIPA model 210 and/or the like for determining, based on the set of data features, second user data associated with the user. As described herein, the second user data may be associated with one or more of financial data, PII, demographic information, personal relationship data, life event data, behavioral data, cost-of-living data, user device data, and/or social media data associated with the user.

As shown by operation 1310, the apparatus 200 may include means, such as MIPA model 210 and/or the like for generating, based on the first user data and the second user data, a first model response.

As shown by operation 1312, the apparatus 200 may include means, such as MIPA management circuitry 208 and/or the like for providing the first model response to the user via a second user device (e.g., user device 108B). In this regard, any information ingested by the MIPA model 210 via a first user device (e.g., user device 108A such as a smart home device or laptop utilizing a web browser) may be processed by one or more processing devices (e.g., server systems, computing devices, etc.) of the MIPA system 102 to provide a continuous user experience, and may enable a user who interacted previously with the MIPA model 210 via the first user device (e.g., the user device 108A) to pick up where the user left off via a second user device (e.g., a user device 108B such as a smartphone utilizing a software application instance associated with the MIPA system 102, and/or the like) at a later time.

For example, if the respective user initiates a conversation with the MIPA model 210, begins exploring a scenario, or starts to formulate a set of goals via a first platform (e.g., user device 108A such as a smart home device located in the user's kitchen), the user may continue said discussion, scenario exploration, and/or goal formulation via a second platform (e.g., user device 108B such as smartphone utilizing a software application instance associated with the MIPA system 102) as the user leaves their home. In this regard, the MIPA system 102 may be configured such that a user profile (e.g., an initial user profile, a current user profile, and/or one or more models (e.g., a suite of ML associated with the MIPA model 210) associated with a respective user is continuously updated based on each interaction with the user no matter which modality the user utilizes to access the MIPA system 102.

As such, the MIPA management circuitry 208 may be configured to facilitate a second interaction between the user and the MIPA model 210, where the second interaction is facilitated on a third user device (e.g., user device 108C) associated with the user. In such an example, the MIPA model 210 may be configured to extract, based on second user input received during the second interaction, a second set of data features associated with the user and determine, based on the second set of data features, third user data associated with the user. The MIPA model 210 may be configured to then generate, based on the second user data and the third user data, a second model response, where the MIPA management circuitry 208 is configured to provide the second model response to the user. Additionally, the MIPA model 210 may be configured to generate at least a first pathway associated with the user based on based on the first user data, the second user data, and the third user data, where the first pathway is an actionable plan associated with one or more of a primary goal, a set of subgoals related to the primary goal, a set of insights, a set of important considerations, a set of product offers, a set of opportunities, a set of scenarios, a set of action item lists, or a set of tradeoffs.

In various examples and as described herein, one or more of the first interaction or the second interaction may be associated with one or more of a conversational interaction, a documentation upload interaction, and/or a video-based interaction. Additionally, one or more of the first user input or the second user input comprise text input data, audio input data, and/or video input data associated with the user (e.g., associated with one or more text data streams, audio data streams, and/or video data streams respectively). In such examples, the MIPA model 210 may be configured to extract a set of user input data features from the second user input and determine, based on the set of user input data features, a set of user input attributes associated with the second user input. The MIPA model 210 may be configured to generate the second model response based on the set of user input attributes.

In some examples, the set of user input attributes may indicate one or more of a user sentiment, a user intent, a user tone, a user emotion, a level of technicality, or a level of subject matter knowledge of the user. The MIPA model 210 may be configured to determine, based on a set of user input attributes, an appropriate response format for responding to the first user input and/or second user input and generate the second model response according to the appropriate response format. For example, if the MIPA model 210 determines, based on the set of user input attributes, that the user is agitated and/or appears to be in hurry, the MIPA model 210 may generate the second model response in a short-form format (e.g., a short audible reply, a short SMS message, and/or the like). As another example, if the second user input such is a technical question that warrants a lengthy response and/or explanation, the MIPA model 210 may generate and email a transcript of a model response to the user rather than produce an audible reply that may take several minutes to read aloud. In such an example, the MIPA management circuitry 208 may be configured to provide a notification to the user that the second model response has been generated according to the appropriate response format (e.g., a transcript of a long-form model response), where the notification may indicate a means in which the user can access the second model response (e.g., an email account associated with the user).

Additionally or alternatively, the MIPA model 210 may be configured to determine one or more inferred character traits of the user and determine the appropriate response format with which to generate the second model response based on the one or more inferred character traits of the user. For instance, in an example in which the MIPA model 210 has previously determined that a user is tech-savvy and/or knowledgeable in subject matters related to technology, the MIPA model 210 may generate the second model response using technical language and/or terminology as the user will likely be able to comprehend such language and/or terminology. Similarly, if the MIPA model 210 determines that the user works in a particular field (e.g., real estate), the MIPA model 210 may generate various model output (e.g., model responses) using language, terminology, statistics, and/or high-level concepts related to the particular field, as the user will likely understand.

Alternatively, if the MIPA model 210 determines that the user is not knowledgeable in certain subject matters, the MIPA model 210 may generate model responses using simple language, terminology, and/or explanations so that the user is more likely to comprehend. Additionally, over time the MIPA model 210 may determine that a user prefers a particular response format for various model response and may generate various model responses according to the user's preferred formats. For example, a user may prefer that the MIPA model 210 generate SMS messages and/or text-responses in a software application instance associated with the MIPA system 102 so that the user will be able to maintain a record of the model responses generated by the MIPA model 210.

FIGS. 9-13 illustrate operations performed by apparatuses, methods, and computer program products according to various examples. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

As set forth above, certain methods or process blocks may be skipped or omitted in some implementations. Blocks or operations may be added to some implementations. The methods and processes described herein are also not limited to any particular sequence or order, and the blocks or operations relating thereto can be performed in other sequences or orders that are appropriate. For example, described blocks or operations may be performed in an order other than that specifically disclosed, or multiple blocks or operations may be combined in a single block or state. For instance, two or more blocks or operations may be executed concurrently or with partial concurrence. The example blocks or operations may be performed in serial, in parallel, or in some other manner. For example, the order of execution of two or more blocks or operations may be scrambled relative to the order described. For instance, two or more blocks or operations may be executed concurrently or with partial concurrence. It is understood that all such variations are within the scope of the present disclosure.

### Conclusion

As described above, examples provide methods, systems, apparatuses, and computer program products that offer multimodal interactive personal advice. Examples thus provide tools that overcome the problems faced by conventional methods for determining, planning, and/or tracking a user's goals. Examples provide the added benefit of automating the model-based identification of a user's financial outlook, goals, objectives, and/or potential opportunities based on a variety of interactions (e.g., conversations, chats, user interface interactions, video-based interactions, and/or the like). In addition to automatically identifying a user's goals, embodiments described herein provide the benefit of generating a user-specific plan (e.g., a pathway) and/or identifying contextual opportunities with which a user may take action in order to accomplish their goals and objectives. Furthermore, the MIPA system described herein provides the benefit of executing various action items related to a user's goals and/or objectives on behalf of the user without requiring manual input from the user, thus saving time and resources.

Many modifications and other examples of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples disclosed and that modifications and other examples are intended to be included within the scope of the appended claims. Moreover, although the foregoing descriptions and the associated drawings describe examples in the context of certain example combinations of elements and/or functions, it should be appreciated that different combinations of elements and/or functions may be provided by alternative examples without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

In addition, conditional language, such as, among others, “can,” “could,” “might,” or “may,” unless specifically stated otherwise, or otherwise understood within the context as used, is generally intended to convey that certain examples include, while other examples do not include, certain features, elements and/or steps. Although this disclosure has been described in terms of certain examples and applications, other examples and applications that are apparent to those of ordinary skill in the art, including examples and applications that do not provide all of the benefits described herein, are also within the scope of this disclosure. The scope of the inventions is defined only by the appended claims, which are intended to be construed without reference to any definitions that may be explicitly or implicitly included in any incorporated-by-reference materials.

What is claimed is:

1. A multimodal interactive personal advisor (MIPA) system comprising:
user data circuitry configured to retrieve first user data associated with a user;
MIPA management circuitry configured to:
facilitate a first interaction between the user and an MIPA model, wherein the first interaction is facilitated on a first user device associated with the user; and
the MIPA model, wherein the MIPA model is configured to:
extract, based on first user input received during the first interaction, a first set of data features associated with the user;
determine, based on the first set of data features, second user data; and
generate, based on the first user data and the second user data, a first model response, wherein the MIPA management circuitry is configured to provide the first model response to the user via a second user device associated with the user.

2. The MIPA system of claim 1, wherein:
the MIPA management circuitry is configured to facilitate a second interaction between the user and the MIPA model, wherein the second interaction is facilitated on a third user device associated with the user; and
the MIPA model is configured to:
extract, based on second user input received during the second interaction, a second set of data features associated with the user;
determine, based on the second set of data features, third user data; and
generate, based on the second user data and the third user data, a second model response, wherein the MIPA management circuitry is configured to provide the second model response to the user.

3. The MIPA system of claim 2, wherein one or more of the first interaction or the second interaction is associated with one or more of a conversational interaction, a documentation upload interaction, or a video-based interaction.

4. The MIPA system of claim 3, wherein one or more of the first user input or the second user input comprise text input data, audio input data, or video input data associated with the user.

5. The MIPA system of claim 4, wherein the MIPA model is configured to:
extract a set of user input data features from the second user input;
determine, based on the set of user input data features, a set of user input attributes associated with the second user input; and
generate the second model response based on the set of user input attributes.

6. The MIPA system of claim 5, wherein the set of user input attributes indicates one or more of a user sentiment, a user intent, a user tone, a user emotion, a level of technicality, or a level of subject matter knowledge of the user.

7. The MIPA system of claim 6, wherein the MIPA model is configured to:
determine, based on the set of user input attributes, an appropriate response format; and
generate the second model response according to the appropriate response format.

8. The MIPA system of claim 7, wherein the MIPA management circuitry is configured to provide a notification to the user that the second model response has been generated according to the appropriate response format, wherein the notification indicates a means in which the user can access the second model response.

9. The MIPA system of claim 7, wherein the MIPA model is configured to:
determine one or more inferred character traits of the user; and
determine, based on the one or more inferred character traits of the user, the appropriate response format with which to generate the second model response.

10. The MIPA system of claim 3, wherein the MIPA model is configured to generate at least a first pathway associated with the user based on based on the first user data, the second user data, and the third user data, wherein the first pathway is an actionable plan associated with one or more of a primary goal, a set of subgoals related to the primary goal, a set of insights, a set of important considerations, a set of product offers, a set of opportunities, a set of scenarios, a set of action item lists, or a set of tradeoffs.

11. A method comprising:
retrieving, by user data circuitry, first user data associated with a user;
facilitating, by multimodal interactive personal advisor (MIPA) management circuitry, a first interaction between the user and an MIPA model, wherein the first interaction is facilitated on a first user device associated with the user;
extracting, by the MIPA model and based on first user input received during the first interaction, a first set of data features associated with the user;
determining, by the MIPA model and based on the first set of data features, second user data;
generating, by the MIPA model and based on the first user data and the second user data, a first model response; and
providing, by the MIPA management circuitry, the first model response to the user via a second user device associated with the user.

12. The method of claim 11, the method comprising:
facilitating, by the MIPA management circuitry, a second interaction between the user and the MIPA model, wherein the second interaction is facilitated on a third user device associated with the user;
extracting, by the MIPA model and based on second user input received during the second interaction, a second set of data features associated with the user;
determining, by the MIPA model and based on the second set of data features, third user data;
generating, by the MIPA model and based on the second user data and the third user data, a second model response; and
providing, by the MIPA management circuitry, the second model response to the user.

13. The method of claim 12, wherein one or more of the first interaction or the second interaction is associated with one or more of a conversational interaction, a documentation upload interaction, or a video-based interaction.

14. The method of claim 13, wherein one or more of the first user input or the second user input comprise text input data, audio input data, or video input data associated with the user.

15. The method of claim 14, the method comprising:
extracting, by the MIPA model, a set of user input data features from the second user input;
determining, by the MIPA model and based on the set of user input data features, a set of user input attributes associated with the second user input; and
generating, by the MIPA model, the second model response based on the set of user input attributes.

16. The method of claim 15, wherein the set of user input attributes indicates one or more of a user sentiment, a user intent, a user tone, a user emotion, a level of technicality, or a level of subject matter knowledge of the user.

17. The method of claim 16, the method comprising:
determining, by the MIPA model and based on the set of user input attributes, an appropriate response format; and
generating, by the MIPA model, the second model response according to the appropriate response format.

18. The method of claim 17, wherein the MIPA management circuitry is configured to provide a notification to the user that the second model response has been generated according to the appropriate response format, wherein the notification indicates a means in which the user can access the second model response.

19. The method of claim 17, the method comprising:
determining, by the MIPA model, one or more inferred character traits of the user; and
determining, by the MIPA model and based on the one or more inferred character traits of the user, the appropriate response format with which to generate the second model response.

20. A non-transitory computer-readable medium storing instructions that, when executed by at least one processor, cause the at least one processor to:
retrieve first user data associated with a user;
facilitate a first interaction between the user and a multimodal interactive personal advisor (MIPA) model, wherein the first interaction is facilitated on a first user device associated with the user;
extract, based on first user input received during the first interaction, a first set of data features associated with the user;
determine, based on the first set of data features, second user data;
generate, based on the first user data and the second user data, a first model response; and
provide the first model response to the user via a second user device associated with the user.
